(19) United States
(12) Patent Application Publication
(10) Pub. No.: US 2002/0044353 A1
(43) Pub. Date: Apr. 18, 2002

(54) Spintronic optical shutter

(76) Inventor: David B. Salzman, Chevy Chase, MD (US)

Correspondence Address: LYON & LYON LLP, 633 WEST FIFTH STREET, SUITE 4700, LOS ANGELES, CA, 90071, US

(21) Appl. No.: 09/847,702

(22) Filed: May 3, 2001

Related U.S. Application Data
(63) Continuation-in-part of application No. 09/247,702, filed on Feb. 10, 1999, now Pat. No. 6,209,433.
(60) Provisional application No. 60/206,597, filed on May 24, 2000.
(60) Provisional application No. 60/201,916, filed on May 4, 2000.

(51) Int. Cl. G02B 27/28

(52) U.S. Cl. 359/488; 385/11

(57) ABSTRACT

An ultra-fast shutter apparatus and methods for reading and writing optical intensities are disclosed. The shutter uses a spintronic device exploiting the quantum Faraday effect to sample or modulate the intensity of an optical data stream, preferably as bits in a digital data train. The methods set or sample the intensity. A useful application of the methods and apparatus sets or samples optical intensities, taking or putting them, whether in optical or electrical form, optionally at a demultiplexed bus width or data rate.

### RELATED APPLICATIONS

This application claims priority to U.S. provisional application Serial No. 60/201,916, filed May 4, 2000, by David Salzman,.

### FIELD OF THE INVENTION

The present invention generally relates to optical communications and, more particularly, to using spectronics in optical communications.

### BACKGROUND

Ultra-fast optical shutters can be used for digital and analog applications. Important uses include reading (sampling) or writing (modulating) bits in a digital data stream, and sampling a waveform for a precise duration, perhaps at a precise time, in the manner of a camera shutter or a sampler for a range finder or an analog-to-digital converter.

One important prior art family of ultra-fast analog and digital shutters uses interferometers to perform comparable functions to the shutter described herein, even though the internal design and operating physics differ greatly. Patents such as U.S. Pat. Nos. 6,014,237; 5,999,292; 5,999,287; 5,959,793; 5,956,437; 5,917,979; 5,828,474; 5,825,519; 5,822,471; 5,764,396; 5,710,845; 5,687,260; 5,646,759; 5,625,727; 5,493,433; and 5,347,608 that disclose embedding Symmetric Mach-Zehnder (SMZ) and Terahertz Optical Asymmetric Demultiplexer (TOAD) devices provide some examples, and are hereby incorporated herein by reference for all purposes. Also included by reference are applications of the Ultrafast Nonlinear Interferometer (UNI), Colliding Pulse Mach-Zehnder (CPMZ), and Michaelson interferometers.

The optical amplifiers serving as non-linear elements within interferometers can ensure high speed operation. In general, a device requiring use of a semiconductor optical amplifier (SOA) or fiber optical amplifier (FOA) is subject to the amplifier's nsec-scale restoration time. It is possible however to exploit 1-10 psec-scale effects within a low duty cycle while waiting for the amplifier to restore. Nakamura has shown that using non-linear elements in both arms of a SMZ interferometer allows one side to open the shutter and the other side to close the shutter, avoiding the need to wait for an exponential tail to decay. Researchers at NEC have split and delayed the opening and shutting signals, cross polarized them, fed them through an optical amplifier acting as a single arm interferometer, restored their polarizations, and superposed them, which is simple but very sensitive to aging and intolerant of inexact construction.

Hall has exploited Kerr rotation in a single arm interferometer (the Ultrafast Nonlinear Interferometer (UNI)), where the optical amplifier mutually dephases a pair of time-splayed signals. A UNI, shown in prior art FIG. 1, can be set up as a one-armed interferometer, avoiding the intrinsic instability of a Sagnac, Michelson or Mach-Zehnder interferometer. The UNI prior art is described by excerpt:

The principle of operation is as follows: ultrafast Clock (signal) pulses, launched into the “Signal in” port propagate through birefringent fiber (BRF) and are split into two orthogonally-polarized pulses. These two Clock components traverse the polarization insensitive SOA, are temporally recombined in a second length of BRF, and are interfered in a fiber-coupled polarizer. The UNI may be biased ON or OFF by adjusting the polarization controller in front of the output polarizer. The ultrafast data (control) pulses are launched into the “Control in” port and temporally overlap one of the two Clock components within the SOA. The control pulse induces picosecond, as well as long-lived, changes in the refractive index and gain of the SOA. The coupling of the gain and the refractive index in a SOA is one of the factors that makes SOA-based switches more complicated to operate than fiber based switches. In the UNI, long-lived (nanosecond) refractive index changes are sensed equally by both Clock components, so the switching operation is relatively insensitive to these changes. However, picosecond refractive index nonlinearities induced on one of the two Clock components by the overlapping data pulse changes the polarization of the recombined signal components and switches the transmission at the output polarizer. An optical band-pass filter at the switch output passes the switched-out Clock pulses and rejects the controlling data pulses.

(K. L. Hall, K. A. Rauschenbach, S. G. Finn, R. A. Barry, N. S. Patel, and J. D. Moores, “100 Gb/s Optical Network Technology.” Digest of the IEEE/LEOS 1996 Spring Topical Meetings—Ultrafast Electronics and Optoelectronics, 1997 OSA Technical Digest Series, Paper UMA2, p. 3, March 1997.) The excerpted description is not quite complete. The input also needs to assert linear 45° polarization or the device will not work reliably. The 50:50 splitter (actually, a joiner) need not be 50:50; it simply matches the intensities of the control (Clock) pulse and half of the signal pulse.

The TOAD is the most advanced of these. FIGS. 2A-2E illustrate some examples. Prucnal (FIG. 2E) has greatly simplified the SMZ as a TOAD in Sagnac (FIG. 2A) and Mach-Zehnder (FIG. 2B) configurations, and has demonstrated a 1.6 psec shutter.

A second family of prior art ultra-fast shutters exploits the quantum Faraday effect (a spintronic rotational effect) without requiring stimulated emission. Examples include work by Tackeuchi, Miller, and others. At a physics level, the quantum Faraday effect occurs because the aligned spins create different indices of refraction for left circularly polarized and right circularly polarized light, which the linearly polarized light contains in equal amplitudes, so the phase of the circular components shifts during passage through the interaction region, rotating the angle of linear polarization. This disclosure shows how to exploit the effect to change the birefringence of an interaction region temporarily, notably when the interaction region comprises a plurality of structures such as patterns within a larger piece of material. It can also change the reflectivity of an interface, such as by aligning the spins of a 2DEG so that incoming oppositely polarized light is reflected. Or, it can modulate the absorption of circularly polarized light, so pumping by a first circularly polarized pulse modulates the transmission of a second similarly circularly polarized pulse of lower intensity.

In the discussion of circularly polarized light which follows, the addition of light with a linearly polarized component strictly speaking gives elliptical eccentricity. The linear polarization contribution can be ignored for the purposes of clarity in these discussions, and the concept of elliptical polarization is encompassed when we mention circular polarization. However, too much circular polarization added to light we describe as linear will make that linearly polarized light begin to act like an appreciable superposition of linear and circular sources.

In spite of the first family's prior art successes in exploiting 1-10 psec-scale effects using optical amplifiers, at the cost of a low duty cycle, devices using optical amplifiers suffer from many disadvantages. Deleterious effects arise from carrier heating, carrier depletion, resistive (I²R) heating, and other consequences of carriers moving. Limitations also arise on the allowable energy per bit due to the need to avoid or respect the amplifier's non-linear regime. Gain saturation and noise floors are always a concern. Mechanisms for coupling-in of the nsec-scale phenomena limit high speed performance. Temperature dependence and frequency dependence limit operating specifications. Amplified spontaneous emission can be particularly limiting. Additionally, these devices rely on time-dependent changes in the local speed of light due to subtle changes in a material's refractive index for certain carrier populations in a conduction band. Because the refractive index changes are so small, it can take millimeters to meters of device to accumulate μm-scale changes in the relative distance light propagates. Small aging effects like part-per-million per month changes in dopant concentrations can drift, degrade, and ruin these devices within a few years.

Devices using the second family's prior art have also traditionally suffered from numerous disadvantages. These include time-dependent instabilities and nsec-scale recovery times such as index drift due to excessive carrier heating; appreciable area under the exponential tail, leading to DC wander; the need for expensive multiple quantum well materials instead of bulk materials; noisy performance or poor extinction ratios, and the difficulty of shrinking and cost reducing the constituent devices.

Of course, the non-linearity of devices drawn from the second family can be used as non-linear elements in the first family, potentially avoiding problems arising from use of optical amplifiers. Problems remain however due to extreme tolerance requirements (much smaller than a wavelength of light) and other limitations.

These various problems in aggregate, as well as trade-offs made to avoid them, can force high costs, low reliability, difficult design, low yield, large size, fragile construction, field failures, unattractive trade-offs, and high complexity, whether at device or system level.

### SUMMARY OF THE INVENTION

An ultra-fast shutter apparatus and methods for reading and writing optical intensities are disclosed. The shutter uses a spintronic device exploiting the quantum Faraday effect to sample or modulate the intensity of an optical data stream, preferably as bits in a digital data train. The methods set or sample the intensity. A useful application of the methods and apparatus sets or samples optical intensities, taking or putting them, whether in optical or electrical form, optionally at a demultiplexed bus width or data rate. For instance, an apparatus in accordance with the invention may generally include a circularly polarized pump beam, a linearly polarized probe beam following it in an interaction region, and a linear polarizer to filter the probe beam output. The material with a region where the pump signal and probe beams interact may be a spintronic material.

### BRIEF DESCRIPTION OF THE DRAWINGS

Other objects, features and advantages of the present invention will become more apparent from the following detailed description when read in conjunction with the accompanying drawings, in which:

FIG. 1 illustrates a prior art Ultrafast Nonlinear Intererometer.

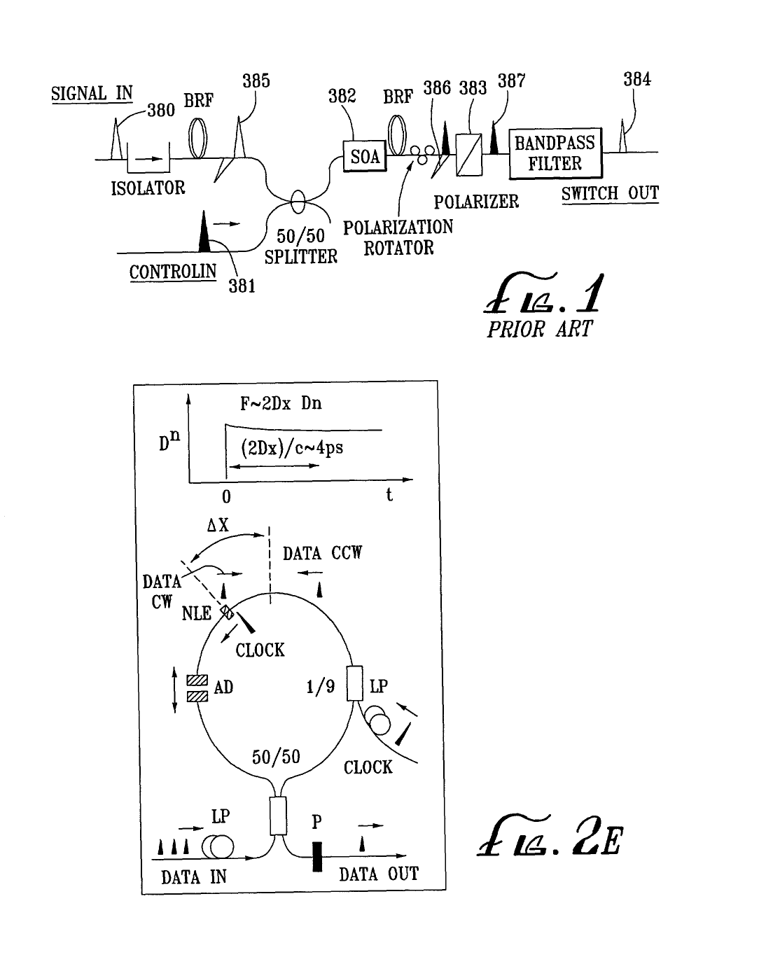

FIGS. 2A-E illustrate various prior art Terahertz Optical Asymmetric Demultiplexer (TOAD) devices.

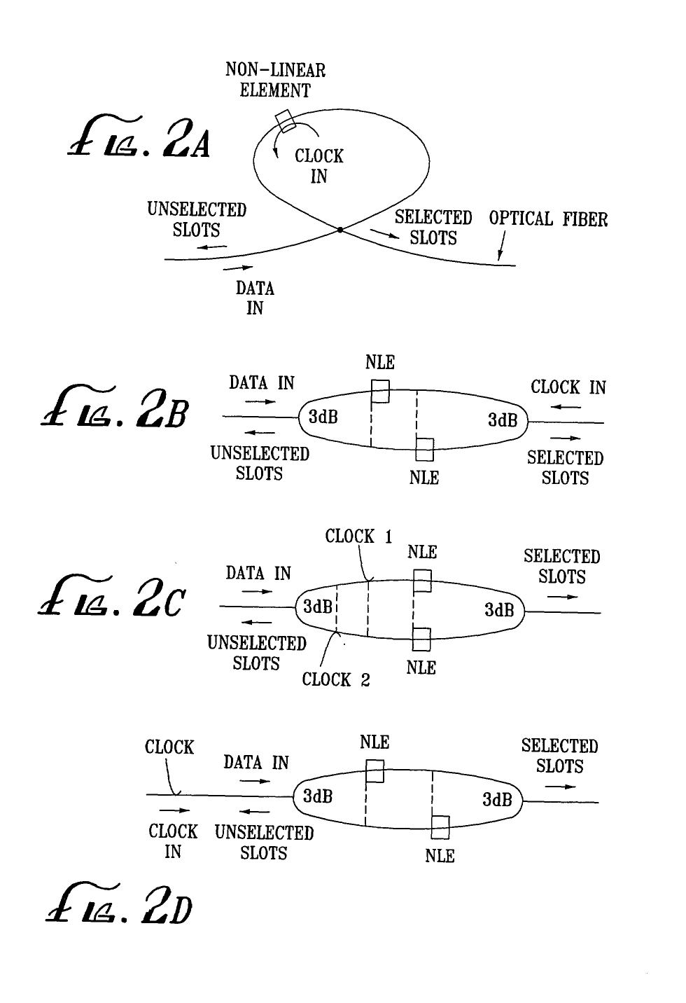

FIG. 3A illustrates a prior art technique and apparatus for measuring the quantum Faraday effect.

FIG. 3B shows prior art data from a spintronic material in the presence of an applied magnetic field.

FIG. 4 illustrates a spintronic apparatus in accordance with the invention.

FIG. 5 enumerates the choices among modulated and reference bitstreams, with a worked example.

FIGS. 6 and 7 illustrate a common communications system architecture implemented in accordance with the invention, logically and schematically.

FIG. 8 illustrates the applications of useful variants of apparatuses and methods in accordance with the invention.

FIGS. 9A-B illustrate canonical detection schemes using a multiplicity of detectors.

FIGS. 10A-C depict optical logic, sampling, and regeneration in accordance with the invention.

FIGS. 11A-E illustrate a variety of logic states indicative of typical embodiments of the invention in systems.

FIGS. 12A-G illustrate concepts of optical regeneration in accordance with the invention.

FIGS. 13A-B illustrate the concept of resetting using the invention.

FIG. 14A shows a prior art apparatus used to measure a spintronic effect, as well as data.

FIGS. 14B-D illustrate a variety of additional embodiments of the invention.

### DETAILED DESCRIPTION OF THE INVENTION

The present invention is directed to systems and methods for optical communications using spintronics. Spintronics effects depend on the net spin orientation \hat{σ} in an interaction region of a material. Spintronics may be used to build, for example, an ultra-fast optical sampler or modulator.

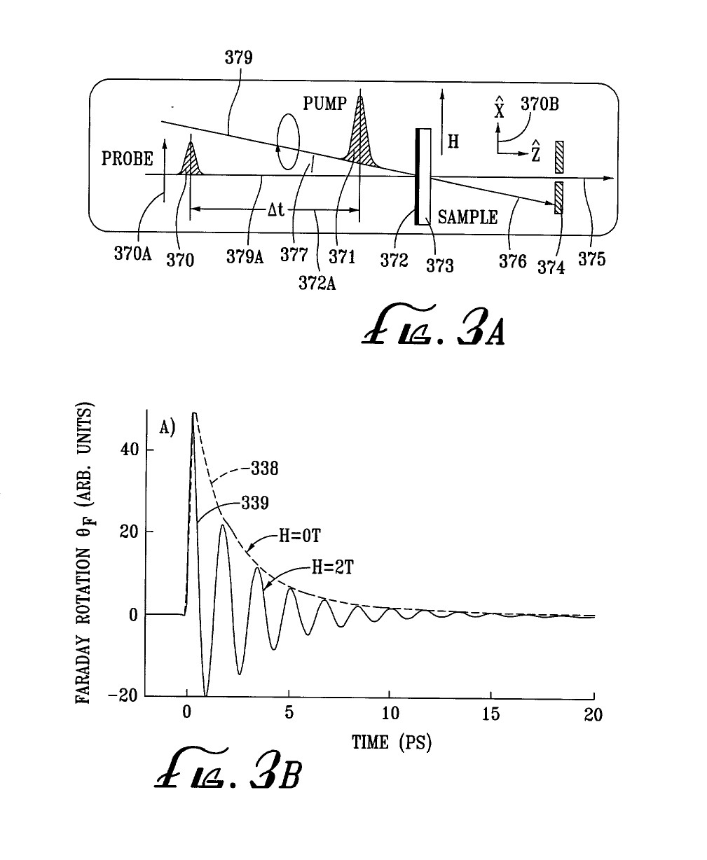

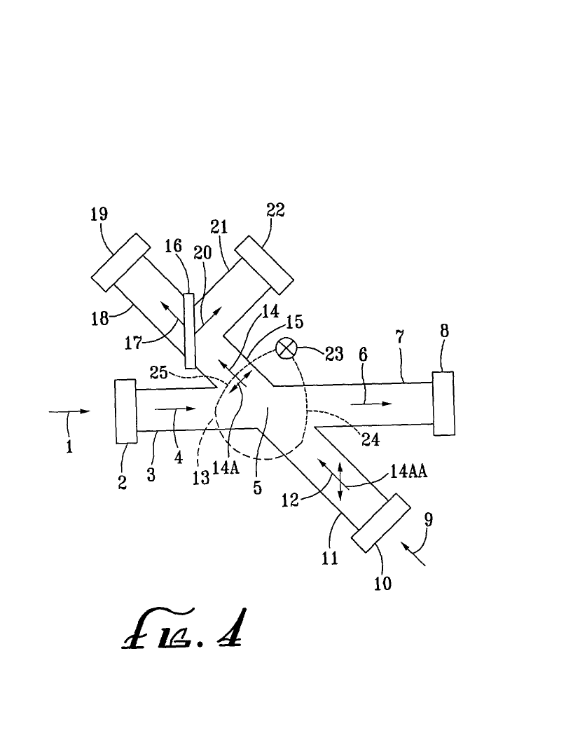

Consider the quantum Faraday effect, as depicted in FIG. 3A. It relies on either no magnetic field or a field applied transverse to the direction of the light beam, whereas the better known classical Faraday effect exploits a magnetic field parallel to the light. In the quantum Faraday effect with a magnetic field B present, \hat{B} is the basis state for quantization, so excited electron spins \hat{σ} project along the \hat{B} axis and precess about it. The carriers are typically electrons, not holes. In the quantum Faraday effect without a strong magnetic field B present, there is no net non-zero \hat{σ}. Research has shown that the quantum Faraday effect causes circularly polarized pulses in a train to rotate the polarization angle of a linearly polarized probe pulse. Specifically, “The circularly-polarized optical pump pulse selectively excites either spin-up or spin-down excitons in the Mn heterostructure sample 373. These excitons spin-scatter and perturb the magnetization of the embedded magnetic moments. This perturbation to the sample magnetization is measured by the Faraday rotation imparted to a time-delayed linearly-polarized probe pulse.” J M Kikkawa, I P Smorchkova, N Samarth, D D Awschalom, “Room Temperature Spin Memory in Two-Dimensional Electron Gases. Science, Vol 277, Aug. 29, 1997, pp. 1284-1287. Another view of the phenomenology can be found in A. Tackeuchi, T. Kuroda, S. Muto et al., “Electron spin-relaxation dynamics in GaAs/AlGaAs quantum wells and InGaAs/InP quantum wells,” Japanese Journal of Applied Physics Part 1-Regular Papers Short Notes & Review Papers 38 (8), 4680-4687 (1999), hereby incorporated by reference. (Also see U.S. Pat. Nos. 5,151,589 and 5,650,611.)

Faraday rotation is an inherently absorptive process. The color of the pump 371 should be tuned near the heavy hole absorption edge, e.g., near 1.55 μm in appropriately doped InP. The probe 370 can be of any nearby color, but will be attenuated substantially if above the band edge.

The rotation of the polarization angle 377 of the linearly polarized probe pulse 376 is limited in proportion to the absolute value of the cosine of its angle with the circularly polarized light beam, so the beams should ideally be close to parallel or anti-parallel. Polarization rotation also depends on several other variables, including the intensity of the data pulse, a time-decaying exponential, the magnetic field strength, and detail-dependent material and geometry specifics of the interaction region. Note that elliptical polarization is projected to the case of circular polarization at the minor eccentricity's intensity.

FIG. 3B shows that the exponential envelope 388

e^{-Δt/T}₂* (1)

attenuates the amplitude of the linearly polarized light's polarization component perpendicular to its initial polarization angle. This occurs due to dephasing of the electron spins, hence of the total \hat{σ}. The dephasing time constant T₂* is the transverse spin relaxation time in an optically active material, as in NMR, and is typically psec-scale at room temperature. It measures the statistical consequences of the finite temperature, magnetic and susceptibility inhomogeneities within the material, phonon scattering, and other psec-scale effects. T₂* can advantageously be hastened by using a more dielectric material, such as a p-doped semiconductor with a low doping concentration. Magnetic semiconductors can also speed up T₂* and enhance the magnitude of the effect, although present magnetic semiconductor materials are not suitable for use at room temperature. Dephasing is much faster than decoherence. Decoherence, a nsec-scale phenomenon, measures the irreversible loss of information from a spin site, and is primarily a consequence of coupling between the spins and orbital motion, and secondarily of coupling between spins and the lattice.

Within the exponential envelope, the probe's polarization angle varies as

$$cos ( \frac{g {μ}_{B}}{ℏ} B Δ t ) \qquad ( 2 )$$

where μ_{B} is 9.3×10⁻²⁴ J/tesla, [symbol] is Planck's constant, B (actually, H) is in tesla projected across the probe's direction, and t is in seconds. The g factor is entirely material dependent, e.g. g=−0.4 in GaAs, g=1 approximately in ZnSe, g=10 in InAs, etc. The angle has been measured as 15 GHz/tesla at room temperature for InAs. The oscillatory curve would collapse to the exponentially decaying envelope if the applied field B were zero.

Using these principles, spintronics can be used to build an ultra-fast optical sampler or modulator. It offers important advantages compared to prior art approaches. For instance, there is negligible Joule heating, because the quantum Faraday effect modulates the phase of the spin but scarcely moves charges: I²R is nearly 0 since net current flow is nearly zero. In contrast, for a laser cavity or optical amplifier to work, carriers need to be moved some non-zero distance, so their cooling time depends on the field strength and is tens to thousands of psec. The following will show how to normalize out carrier heating in a spintronic device, since dephasing due to the thermal lifetime takes so much longer than decorrelation from inhomogeneities in the local magnetic field and crystal structure. Carrier depletion does not affect the time constants to first order, which is another advantage compared to devices relying on the population of the conduction band such as optical amplifiers. Carrier depletion does however strongly affect the received signal intensity. Gain saturation is discussed below.

Referring back to FIG. 3A, we can exploit the presence or absence of a pulse 371 in a pump beam 379:

Off: In the complete absence of a circularly polarized pulse, the spins of free electrons in the conduction band would not be excited into orientations parallel to the pump beam 379 (i.e. transverse to the magnetic axis basis), so the linearly polarized probe pulse would not undergo appreciable polarization rotation, except for static rotational effects due to the choice of material which can be normalized out.

On: If a circularly polarized pump pulse 371 hits the interaction region, it will cause many of the conduction electrons to respect it instead of the basis asserted by the applied magnetic field. The fraction is estimated to be 10% of the electrons for 10 average μW of pump power; the fraction increases secularly for higher power signal pulses, but more power contributes far fewer carriers per added photon, which is an effect analogous to gain saturation. The linearly polarized probe beam rotates its polarization by an angle which depends, in the limit of small rotation angles, linearly on the number (fraction) of aligned, in-phase carriers it encounters. This is the spintronic (quantum Faraday) effect.

The response in preferred embodiments is idealized as linear, and there is no significant non-linearity encountered until much higher power light is involved than the 10 mW maximum values intended here. For example, a range of 10 μW-10 μW superposition of the affected photons is advantageous. Perfect superposition is unfortunate, to the extent that gain and equalization may need to be provided elsewhere; it is a good thing insofar as there is no time wasted on carriers communicating with one another.

The spintronic approach of the present invention has important advantages compared to any interferometer-based ultra-fast optical modulator. The present invention uses a simple polarizer instead of an interferometer. For example, it may filter against angular (Kerr-like) rotation, which is robust even when inexact, instead of relying on subtle destructive interference patterns. For instance, an apparatus in accordance with the invention may generally include a circularly polarized pump beam, a linearly polarized probe beam following it in an interaction region, and a linear polarizer to filter the probe beam output. Tackeuchi's systems may use a similar apparatus, but with numerous restrictions. A comparable TOAD or SMZ uses two high precision 50:50 splitters, an expensive optical amplifier, and very precise waveguides. All also may use a low precision splitter to couple in a clock, and optionally one or more isolators. The preferred embodiment's interaction region and accompanying optical paths are very simple to make and do not require wavelength-scale alignment precision. Nor do they require long interaction lengths or long, low-bend optical paths. In contrast, the excessive difficulty of manufacturing reproducible, reliable, affordable nonlinear elements embodied as optical amplifiers and precision waveguides, as well as their high amplified spontaneous emission and marginal signal-to-noise ratio (SNR), have prevented interferometer-based optical modulators from finding market acceptance. The present invention is much more forgiving of machining tolerances and details of alignment (mm versus sub-micron), and much less sensitive to small errors in refractive index, time-dependent aging effects, and statistical fluctuations. The material with a region where the pump signal and probe beams interact may be a spintronic material.

Some of the objectives, benefits, and applications of the invention may include an ultra-fast spintronic apparatus and method for using it, for: (1) solving various problems indicated above; (2) quantum Faraday rotation or the quantum Faraday effect; (3) using a spintronic effect instead of an electronic effect; (4) rotating an angle of polarization; (5) sampling analog optical waveforms; (6) modulating analog optical waveforms; (6) reading digital symbols from optical data streams; (7) detecting the values of data symbols, such as bits or multi-level states; (8) reading or writing packets of bits; (9) writing digital symbols into optical data streams; (10) use as an optical shutter, sampler, and/or modulator; (11) reducing carrier heating; (12) reducing carrier depletion; (13) avoiding long interaction lengths; (14) avoiding optical fibers; (15) avoiding birefringent waveguides, such as in fibers (16) avoiding optical amplifiers, optical amplification, and stimulated emission; (17) increasing a signal's amplitude without using an optical amplifier; (18) regenerating a signal; (19) retiming a digital signal; (20) reshaping a signal; (21) equalizing a digital signal; (22) darkening digital Off states; (23) brightening digital On states; (24) retiming a data beam (25) reshaping a data beam; (26) amplifying a data beam; (27) renormalizing or equalizing a data beam; (28) resetting or zeroing symbols, non-electrically; (29) regenerating a data beam; (30) avoiding dark noise and spontaneous emission; (31) improving signal-to-noise ratio; (32) operating at room temperature; (33) changing a material's birefringence; (34) changing a material's reflectivity; (35) changing a material's transmittivity; (36) changing a material's diffractivity; (37) changing a material's refractive index or permittivity; (38) minimizing changes in a material's density of states or conduction band population; (39) handling increased power or avoiding requiring high power; (40) changing the color of a data beam; (41) performing ultra-fast logical operations on data; and (42) handling multistate logic and data.

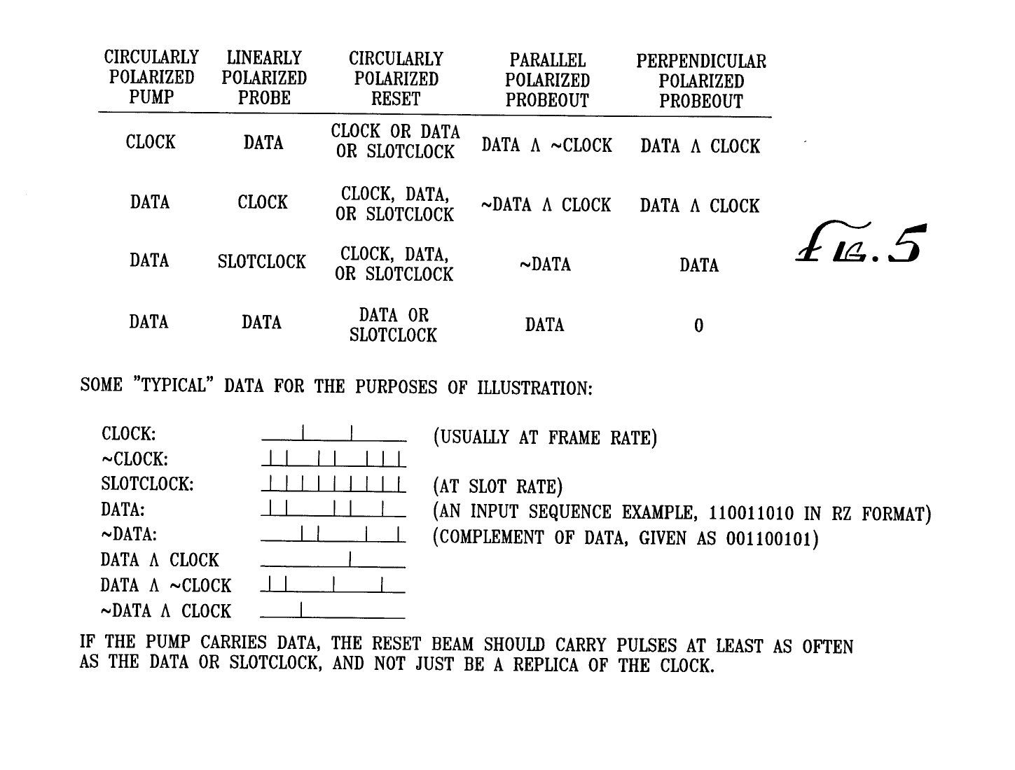

Referring now to FIG. 4, one embodiment includes and operates such that an optical beam 1, preferably modulated as a train of digital data, is introduced into the interaction region 5 by way of a waveguide 3 or optical path 3. Optionally, optics 2 for attenuation, amplification, optical isolation, anti-reflection, asserting a polarization state (e.g. right circularly polarized, or RCP) or other functions may be employed to prepare the beam, resulting in a DataIn beam 4 of RCP pulses.

Each probe pulse 9 is similarly introduced by waveguide 11 or optical path 11 as a linearly polarized pulse 12 into the interaction volume 5 at an angle X° 13 to the axis of the interaction volume, said axis being given by the orientation of the DataIn beam 4. X could be made 0° if the probe pulse 9 and data pulse 1 were different colors; the On/Off ratio will otherwise ordinarily be derated as the absolute value of cos(X). Optional optics 10 may be employed in the manner of optional optics 2 or for other functions. The imposed magnetic field B 23, if any, may preferably be at an angle 24 transverse to the data beam and also at an angle 25 transverse to the probe beam. The exact beam sizes, profiles, and details of the intersecting solid shapes of the overlapped or pursuing data and probe beams in the interaction volume may also influence the magnitude of the measured On/Off effect.

After interacting in interactive region 5, the DataOut beam 6 exits the system by way of a waveguide or optical path 7 at, for example, an angle 180° +X, roughly opposite its point of introduction at an exact position offset by any path corrections induced by the refractive index, birefringence, or other optical complications. DataOut signal train 6 may optionally encounter optics 8 providing optical isolation, a beam dump, preparation for a subsequent stage, or other functions.

In a preferred embodiment, each pulse in the RCP pump beam 4 will cause the angle of polarization of a linearly polarized probe beam chasing it in the “interaction region” 5 of an active material to rotate briefly and then recover. Therefore, if and only if a data bit was On, the linear polarization angle of the probe pulse 9 will get rotated briefly during its passage through the interaction volume. Rotation of the probe pulse 9 due to the history of the data train earlier than the pulse being sensed should of course be minimized, in the interest of maximizing the On/Off ratio sensed for the i'th pulse alone. Such maximization could be made more complicated for a scheme with other codings, such as multistate symbols like trellis coding, but the {0=no pulse, 1=pulse} scheme with RZ coding is simple to describe and probably simplest to build.

A pulse whose angle of linear polarization has been rotated 14 will ordinarily travel through a waveguide or optical path 15, be converted to an amplitude modulated light pulse 17 by transmission through a linear polarizing optical element 16, travel through a waveguide or optical path 18, and then be photodetected or prepared for a subsequent stage by optional optics 19. Optional element 16 may be something other than a linear polarizer. If element 16 is a reflector, then elements 20, 21 and 22 act in the manner of elements 17, 18, and 19, respectively, as described above. If element 16 is a beam splitter, elements 22 and 19 may be used differentially. Differential measurement will be enhanced if element 16 is a polarizing beam splitter, or if it or interactive region 5 include polarization-dispersing or polarization-bending birefringent materials.

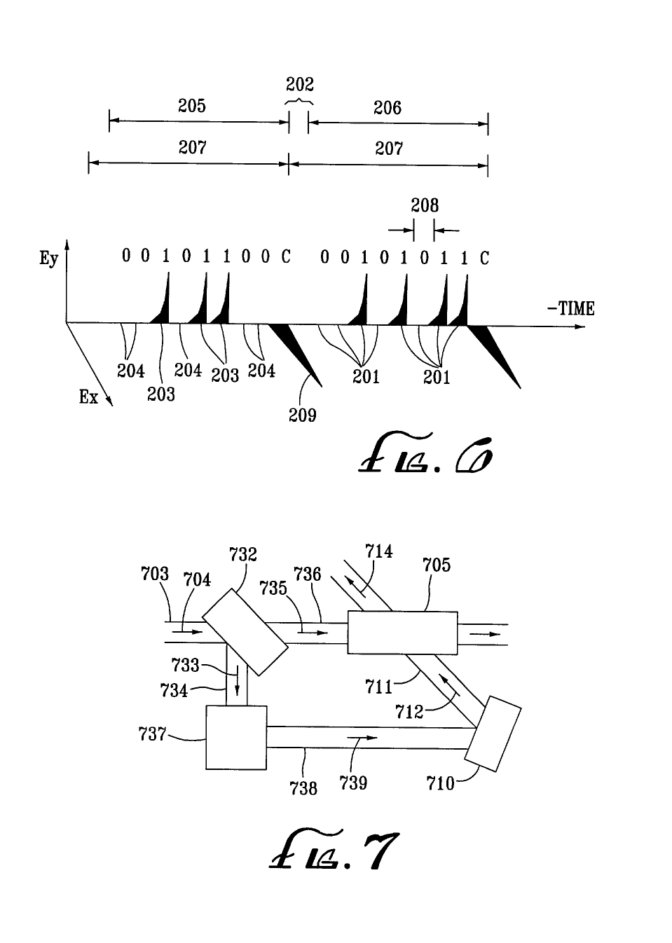

Referring now to FIG. 5, a summary of the output signal for different, illustrative modulations of the inputs, in the case where the probe beam 9 and pump beam 1 are parallel, (i.e. X=0°) and the (optional) reset beam (described in detail later) is perpendicular to them. If the probe beam 9 is oriented perpendicular to the pump beam 1, then care must be taken in defining the sense of the parallel and perpendicular filtered components so that they match (or, by convention, are swapped with) the states indicated for the probe beam 9 parallel to the pump beam 1. The applied magnetic field 23, if any, will preferably be perpendicular to the pump beam 1.

Technically, either the pump or probe can be modulated with a replicated data signal; the other can carry a clock signal, or even, in certain embodiments, a bright field On state. The reset beam is optional and can be omitted or clocked at the slot rate as appropriate. Preferred embodiments may refer to the clock pulse as occurring once per frame.

The circularly and linearly polarized beams described herein are preferably synchronous. They can carry clock and data respectively, or data and clock respectively. If the data is used as a linearly (e.g. vertically) polarized probe, and a clock is used as a circularly (e.g. right) polarized pump, a cross polarizer will ordinarily suppress the probe output. When the clock pump pulse hits, the probe beam will briefly be rotated and read (if a horizontal polarizer filters the output) or suppressed (if a vertical polarizer filters the output). This arrangement of circular clock pulse and linear data train can be advantageous if the data beam is already linearly polarized: unless the data beam is too bright, since too much intensity creates excitons, which would cause photons to scatter and reduce the On/Off ratio. It may also be advantageous unless the probe's duty cycle is too high (e.g. reading every slot), since the spacing between the circularly polarized pulses (e.g. due to Off pulses if the data beam is circularly polarized or due to clocking less than every cycle if the clock beam is circularly polarized) provides an opportunity for the spins in the interaction region to relax back into alignment with the magnetic field (or into isotropically random directions if the magnetic field is negligible). Preferably, the pump beam 1 will carry a train of data pulses and the probe beam 9 will carry a train of clock pulses.

Applications based on the invention preferably detect the probe beam 9, although the invention may include detecting the circular rather than linear polarized beam. Regardless of which polarization is assigned to the data and which to the clock, the linear polarizing filters and beam splitters have better properties today than circular polarizing ones at the same price, and detectors measure dark fields more cleanly than bright fields, so detection of the linear beam is preferred.

The application of principal interest for one of the preferred embodiments here is to read symbols (optical pulses coded as digital bits) less than a few psec wide from timeslots (“slots”) in a commensurately fast baseband data stream manifested as an optical pulse train. The reading device is generally architected to read the symbol from every slot sequentially in a data stream, to read the symbol from one slot periodically (a preferred embodiment), to read the symbol from one slot occasionally, or to read the symbol in one slot by multiple samples of that slot.

Instead of directly detecting the main beam, a preferred embodiment of the method and the apparatus disclosed here periodically introduces a probe pulse to measure the quantum Faraday rotation induced by a single data pulse which is On or Off. The system needs to have a very fast (0.1- 10 psec) shutter speed, even if a longer recovery time is needed before the next exposure. It also needs high SNR and On to Off brightness (extinction or On/Off ratio).

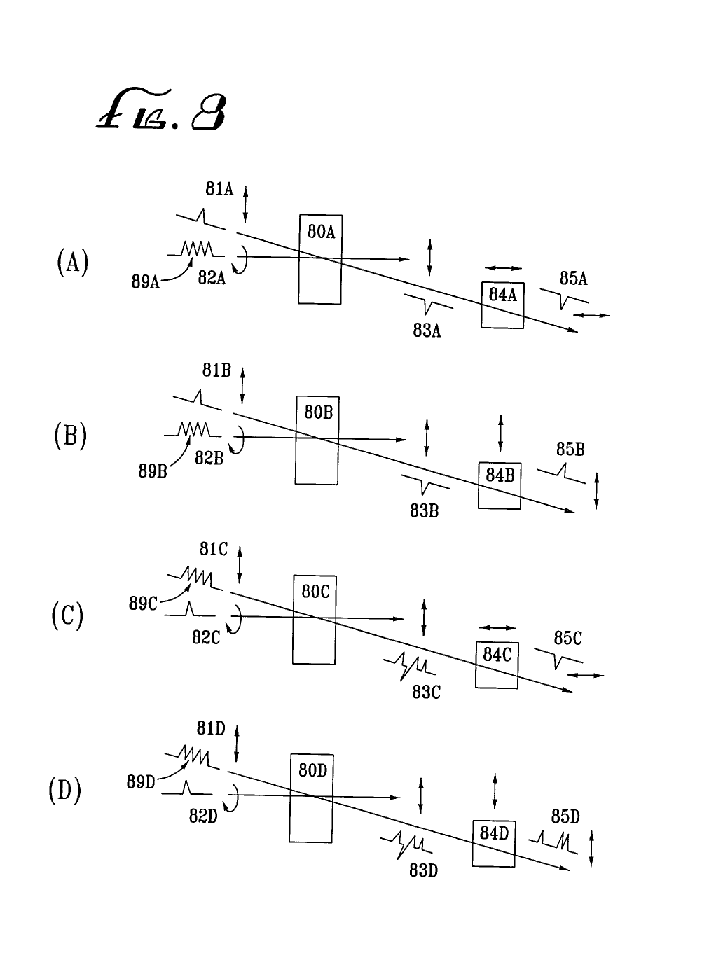

Referring now to FIG. 6, an illustration is provided depicting portions of two typical frames carrying digital data represented as optical pulses. We define a “frame” 205 and 206 as a stream of “n” sequential timeslots 201. Assume that a timeslot has exactly one pulse present (On) or absent (Off), depicted as data 203 and 204, respectively. Now consider a digital communications architecture which senses only one symbol from each slot, namely the bit “1” or “0” occupying slot number “i”, the presence or absence of a pulse.

The SlotClock 208 may be defined as the slot-to-slot periodicity, or the duration of a slot, ideally 1-10 psec. Slot-to-slot periodicity is limited by physics like light pulses breaking up, pulses jittering and recombining with neighbors, or especially the optically active material not recovering quickly enough to an acceptable extinction ratio.

The FrameClock 207 may be defined as the frame-to-frame periodicity, typically 10-1000 psec, given by the duration of a frame 205 plus a small, optional inter-frame delay 202. Frame-to-frame periodicity may be generally limited by the bandwidth of the detector sensor and electronics (for example, conveniently in the 1-40 GHz range).

Reading the bit from only one slot per frame lets the SlotClock 208 be much shorter than the FrameClock 207. For instance, if the detector system needed 1 nsec to recover, each frame would be designed to extend for at least 1 nsec; if the data slots were packed 2 psec apart, each frame would therefore need to carry at least 500 of them (ignoring the inter-frame delay). As explained below, the detector would see a data bit for 2 psec, every 1 nsec.

In a preferred embodiment, each frame carries one clock pulse 209 in addition to the Data pulses 203 and 204 in its data timeslots 201. For clarity's sake, assume that the clock pulse occupies the first slot in each frame and is identically the same color as the data bits, although these simplifications are not mandatory. The clock pulse and data bits could of course readily be distinguished by some combination of position, color, intensity, polarization, bit pattern, and so forth, using filtering techniques well-known to those skilled in the art. The data slots 201 are precisely spaced with respect to the clock pulse 209 and from one another within a frame, but different frames need not be synchronized with respect to one another (i.e. inter-frame delays can differ). None of the slots require mutually coherent phases.

The stream of frames forms a data train. The data beam is therefore a time-varying flux of photons, ordinarily confined to a waveguide or free-space path.

One slot may be read from the data train at the frame periodicity using a detector arranged as follows: For each frame,

1. Split the clock pulse from the data train.

2A. Convert the clock pulse 209 into a linearly polarized probe pulse, if not already linear.

2B. Convert the train of data pulses into a circularly polarized pump train, if not already circular.

3A. Introduce the train of circularly polarized data pulses as a pump train into the “interaction region” of the optically active material.

3B. Delay the probe pulse for “i” time steps, so that it is synchronous with the i'th data slot.

4. Closely follow the i'th data pulse in the “interaction region” of the optically active material with a probe pulse, preferably oriented parallel or anti-parallel to each other. The probe pulse will be rotated by the quantum Faraday effect induced by the contents of a specific (that is, i'th) data slot.

5A. Filter the parallel or perpendicular polarization state of the output probe pulse, defined by convention with respect to the Off or On states.

5B. Introduce the train of circularly polarized data pulses as a reset train into the “interaction region” of the optically active material, perpendicular to the probe beam and pump beam directions, to realign the aligned spin sites into an orientation with zero net angular momentum from the vantage of the probe beam.

6. Read the intensity change of the probe pulse with a (slow) photodetector and electronics. These only need to recover at the frame periodicity. For example, at the frame periodicity divided by the number of detectors ganged in parallel.

7. Wait for the next frame to repeat the process.

Reference is now made to FIG. 7. In this embodiment, the clock pulse needs to be extracted from the incoming beam of light 4 and prepared into a linearly polarized probe pulse 12, while a circularly polarized data train 35 travels along wave guide or optical port 36 to interact with the delayed clock pulse 12 in interactive region 5.

Preparation may entail sharpening, attenuating, etc., as well as changing the polarization state, which is depicted by 10 but should be interpreted as happening anywhere along the waveguides and/or optical paths 34, 38, and 11. A delay line 37 is preferably used to set a precise interval between the extracted clock slot and the i'th slot in the frame. The delay line may preferably have a reprogrammable duration so “i” could be changed. The light travels along 33 and 39 to get to and from 37.

Splitting out the Clock pulse may be a challenge. The Clock pulse may be sampled destructively, leaving the slot empty, or non-destructively, replicating the slot. The fact that a slot holds the special Clock pulse may in principle be established by giving the Clock pulse a special polarization, position, color, multi-bit pattern, or whatever else is practical, although each of these entails complications related variously to dispersion and jitter in the optical waveguide (e.g., fiber) or optical components. In a preferred embodiment, the Clock pulse is distinguished by greater amplitude and being in the first slot in a frame. One approach to extracting the Clock pulse is to use a polarizing beam splitter at 32 to separate out the Clock pulse at the same amplitude. Another approach is to fill the Clock slot with a pulse having 10× the magnitude of the data pulses and vertical linear polarization, and then use a replica of the horizontally polarized data train beam attenuated to 0.01× as the probe beam, relying on the non-linearity of the detector and distinct polarization of the data bits to suppress the data bits compared to the Clock pulse.

Distinguishing the Clock pulse from the data slots may complicate implementation of the architecture. If the Clock has a distinct polarization, the system must use polarizing filters and/or beam splitters, and a means to detect/correct the polarization of the incoming data beam becomes advantageous, albeit expensive. If the Clock can be alone in a wide timeslot, a slow (40 GHz), presumably low cost modulator may be used to open and admit it and close to reject the data slots. A Clock of identical color (perhaps even phase coherent, although that is not necessary) as the data beam can be used for writing symbols onto the data beam, by being extracted/replicated, delayed until the i'th slot, and then OR'd into the i'th slot, if “On” is needed. Such architectures are well-known in the literature. For example, see Prucnal, M. A. Santoro, S. K. Sehgal, “Ultrafast All-Optical Synchronous Multiple Access Fiber Networks,” IEEE J. Select. Areas Communications, SAC-4 (9), ppl484-1493, AON012, hereby incorporated by reference.

A Clock of different color will suffer wavelength-dependent dispersion in the fiber connecting samplers and modulators, so its position may have to be corrected locally. This can be done by well-known methods, such as by extracting the Clock pulse and adjusting its delay relative to a known synch pulse (e.g. the bit in the first slot, always kept On). The adjustment may be done dynamically with feedback or once, at installation, if the environment is sufficiently stable.

Now consider a data train whose slots have already been amplitude modulated with binary data values On or Off. It is advantageous to detect and correct the incoming data beam's polarization on the Poincaré sphere; it is also advantageous to boost/attenuate and equalize the incoming signal. As noted above, the incoming beam of light needs to be circularly polarized. Forcing it into a right or left circularly polarized state is a hard “real-world” constraint with decent but difficult solutions, since optical fibers tend to impose a time-varying elliptical polarization under environmental stresses. The eccentricity of polarization can in principle be corrected by pre-aberrating the beam at an earlier point, compensating at this point, etc., although the practice is harder. An acceptable brute force correction may be to copy multiple polarization-rotated replicas of the incoming beam onto one another, phase coherently except for this rotation, and impose right circular polarization after forming the replicas, before or after recombining them.

The data train may of course be further coded, for instance Manchester encoding the binary bits as 10 for On and 01 for Off so a data bit can be compared to its neighbor. Many well-known coding schemes may be applicable.

After the data train has exited the material, one may either continue using it or absorb & discard it, depending on system architecture considerations. The exit may be by transmission or reflection, discussed elsewhere.

Several considerations weigh on choosing the chemical composition of the optically active or spintronic interactive region material: The material should strongly Faraday-rotate a linearly polarized pulse when pumped by a circularly polarized pulse, and the modulation should be induced predominantly by the most recent data bit rather than from the running history of earlier bits. In one embodiment, the decay rate of the Faraday rotation may be as short as possible, consistent with system performance, pulse width, and SNR. At worst it should not be much longer than the slot period (e.g. a few psec). In another embodiment, the decay rate of Faraday rotation can be longer than the slot rate, since a reset pulse will pull down the square wave before the next slot begins. Operation near room temperature is ordinarily advantageous, and up to 400 kelvins is desirable, although cooling (e.g. with a Peltier cooler) permits use of lower temperature optically active materials at some cost in price and power. A magnetic field can be imposed readily at up to 1.4 tesla; strengths up to double that are feasible. In the interest of affordability, construction should be feasible using standard semiconductor industry tools, materials, and processes.

The interaction region should be made of a direct bandgap semiconductor with almost dielectric properties, such as InAs, InP, or GaAs doped at, for example, less than 10¹⁶ dopant atoms per cm³, giving 10¹⁴ spin sites per cm³. Many II-VI bulk semiconductors provide notably strong Faraday effects at room temperature, and are lattice matched to within 0.1% of GaAs so are easy to grow. P-doping generally gives faster recovery than n-doping, and many materials have strong sensitivity to the dopant concentration. Erbium is a particularly good dopant. The interaction region should be thick enough for the effect to be clear-cut, e.g. 100 nm for tens of millidegrees of rotation. For example, 100 μm of material could be deposited by MOCVD or MBE, giving about 20° of rotation in InAs, since sin(20)=0.34, which is a big signal. Roughly ½ mm would give the optimum 90° of rotation. Thin materials are advantageous, even though they produce <<90° of rotation, since attenuation scales exponentially with thickness whereas rotation scales only linearly.

Multiple quantum well laminates decohere faster than bulk materials, since electrons usually tunnel away more quickly in MQW laminates than in bulk materials, and excitonic relaxation is faster. There are however alternatives to MQW laminates which can cost less and work as well or better at restoring the system quickly.

First, the present invention may rely on dephasing, which is generally fast enough at low energies, not decoherence. The invention therefore does not require MQW structures to operate at psec-scale rates, although MQW materials are permissible. Second, an upper bound on the pump energy (at a few pJ or less per pulse) avoids creating superfluous carriers and excitonic scattering sites in the first place. An important lower bound on pump energy is given by the need to align enough spin sites to create sufficient rotation of the probe pulse. An upper bound on the probe energy may be nominally at 10% of the pump energy; 100% or higher energies are permissible, but tend to reduce the SNR due to exciton formation and scattering events from the excitons. Third, in accordance with the d'Yakanov-Perel spin-orbit interaction, applying a transverse magnetic field (above about 1/100 tesla) splits the conduction band due to the inversion symmetry of the crystal, thereby shortening the dephasing time, especially if there are local magnetic inhomogeneities. Important upper bounds on the field are given by interference effects from the Larmor precession mentioned in equation (2) and the field available from magnetic materials or sources. Fourth, using a lightly doped semiconductor allows the band gap material to retain an almost dielectric conductivity.

Lightly p-doped bulk GaAs (10¹⁶ dopant atoms per cm³ of material) has been shown to be useful for preventing the intrinsically nsec-scale carrier lifetime from slowing the psec-scale dephasing of the spins most recently set by a 6 pJ pump pulse. A lower bound on hole density is given by the need for there to be enough carriers in the conduction band at the operating temperature for there to be enough spin sites to cause appreciable rotation of the probe pulse.

Straining the lattice or lifting the degeneracy between heavy holes and light holes can be advantageous or disadvantageous, depending on the system design. Greater spin-orbit scattering can be exploited to hasten dephasing, and reduced scattering can be exploited to slow dephasing.

In general, an electric field can be used in concert with otherwise optical effects like pumping or resetting to improve or degrade the spintronic effect being sought. For instance, the dephasing time constants can be changed by application of an electric field which injects holes. The carriers may also be scavenged more effectively at room temperature by applying an electric field to Stark-shift the quantum well, using electrodes which are transparent at the relevant frequency. This is advantageous when used with a long-lifetime (e.g. n-doped) material, so the electric field helps dephase the system. Resetting the spins, to be discussed below, provides a non-electrical means for dephasing the system.

The probe's intensity will get slightly attenuated anyway by imperfections, reflections, opacity, etc., and there may be a perturbation due to interactions between the probe and the optically active material apart from the probe's sensing of the data train's interaction with the material. Such effects do not depend on a slot containing an On symbol versus an Off symbol, so can be thought of as time-invariant with respect to the data train. They may need to be corrected to improve the overall SNR. Various interferometer arrangements would readily do this, as noted below. Note that all materials will cause some absorption/attenuation, since the excitation is near the absorption edge, and the Faraday rotation has 1/λ dependence.

An applied magnetic field above the intrinsic internal field (about 40 Oersteds) sets a net spin orientation \hat{B}. After the net spin is reoriented transverse to \hat{B} by a circularly oriented pulse, it Larmor precesses about \hat{B} as mentioned in equation (2) above, cos((gμ_{B}/ [symbol] )BΔt), or roughly 15 GHz/tesla for InAs at room temperature. Affordable permanent magnets are at most a few tesla, so the Larmor precession will be far too slow for the second maximum's position to be near-in, and an applied magnetic field can preferably be used to diminish the exponential envelope and cause the modulation to decay faster than in the absence of an applied magnetic field.

While a preferred embodiment may use a 100 Oersted magnetic field applied transverse to the data and probe beams, the use of a magnetic field is merely advantageous and not actually necessary. Indeed, magnetic shielding may advantageously be used to prevent the interaction region from being influenced by any non-trivial magnetic fields. Note that in certain embodiments of this invention, the magnetic field will advantageously be kept small, in the interest of suppressing the sinusoidal modulation rate and hugging the decaying exponential envelope. If the magnetic field is omitted or kept small (e.g. well below 10 Oersteds), the spin orientations will be isotropically random until a circularly polarized pump pulse briefly forces the net orientation into (approximate) alignment with the pulse's direction of propagation. The figures in this document can advantageously be employed and understood with complete generality where B has negligible magnitude. The dotted line in FIG. 4 shows the B=0 behavior.

If the magnetic field is large enough (e.g. a few hundred kOersteds or more), the precession within the exponential decay envelope might cause the second maximum to appear and complicate the extinction of modulation, so be worth avoiding. Of course, the first zero could be timed to occur as the next symbol appeared while the second maximum would appear later, after exponential attenuation.

An alternative embodiment aligns the probe beam along the magnetic axis, \hat{B}. Alignment of the spin axes along the pump direction (transverse to \hat{B}) when the pump is On, will briefly restore the probe's polarization angle, which otherwise is ordinarily rotated by the aligned spins. These On and Off angles can be filtered with parallel or cross polarization, depending on whether the data or its complement is to be sampled.

It is the intent that the figures and descriptions herein be read generally to include the following canonical cases and their generalizations to other angles: If |B| is negligible, then the probe should be parallel to the pump beam. If |B| is appreciable, then \hat{B} should be perpendicular to the pump beam, and the probe beam should be parallel (or anti-parallel) to either the pump beam or \hat{B}.

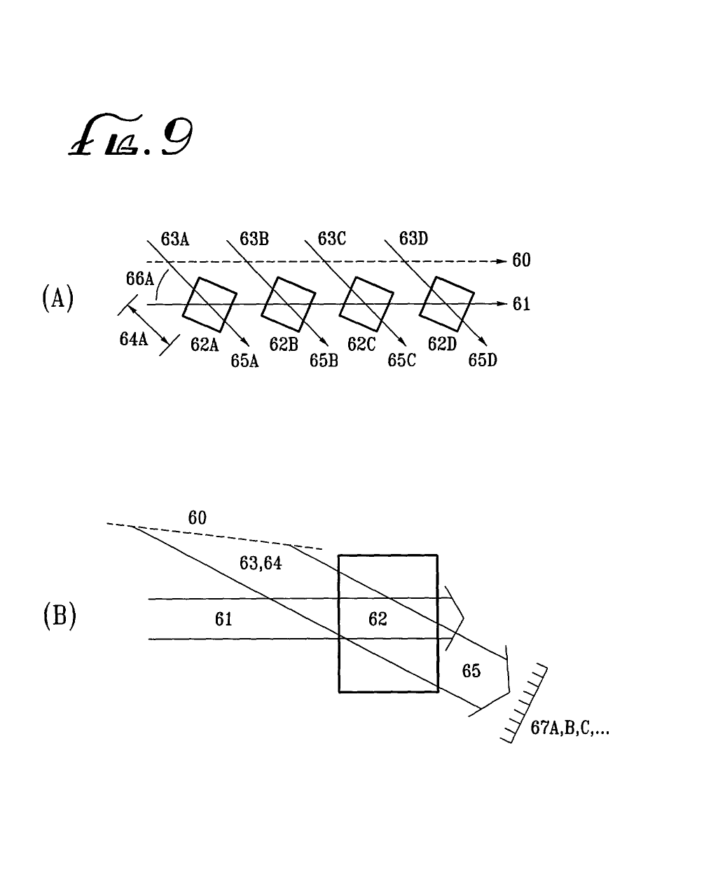

Reference is now made to FIG. 8. After leaving the material, the probe pulse needs to be detected. The polarization rotation can be converted into amplitude modulation by passage through a linear polarizer. Some approaches include direct detection in a photodetector, in which case the polarizer's angle should be set to maximize contrast for the expected extent of rotation which the data beam's intensity induces, optimally by setting it 90° from the original angle; detection of the probe and a replica of it differentially in matched photodetectors; coherent destructive superposition of the probe with its replica using an interferometer, in which case the polarizer should be set parallel to the original polarization angle; and so forth. Use of an optical gain stage between the polarizer and the photodetector may also improve the SNR, although the usual warnings regarding time-dependent effects in optical amplifiers apply. If an interferometer is used, attenuation in the parallel arm may help, and it may be worthwhile to pass the second beam through the same crystal along a different angle or path to encounter some of the same time-invariant effects, e.g. a Mach-Zehnder with one arm probing the data beam and the other balanced by passage through the optical material outside of the interaction region, not sampling the data. Birefringence can advantageously be exploited to advantage for the second interferometer arm's path.

FIG. 8A, FIG. 8B, FIG. 8C, and FIG. 8D explain some useful devices built using the invention with various permutations of linear (e.g. vertically) versus circularly polarized light, and horizontal versus vertical output filtering. FIG. 8A and FIG. 8C can be used as an AND gate or fast shutter, FIG. 8B can be used as a NAND gate, and FIG. 8D can be used as a drop multiplexer. It is the author's intention that the invention be applied to other variants in accordance with this illustrative subset.

Element 80 is the interaction region, idealized as providing a 90° rotation for On and 0° rotation for Off, performing a logical AND function of the Clock and Data pulses, illustrated in the four particularized examples as 80A, 80B, 80C, and 80D. Element 81 indicates a vertical linearly polarized (“LVP”) probe, which is used as the Clock pulse in 81A and 81B, and as the Data beam in 81C and 81D. Element 82 indicates a right circularly polarized (“RCP”) pump pulse, which is used as the Data beam in 82A and 82B, and as the Clock pulse in 82C and 82D. Element 83 is given by the logical AND of 81 with the i'th data slot 89, so provides a 90° rotated (“LHP”) probe for 83A and 83B, and a data train with one symbol in the i=th slot rotated for 83C and 83D. Element 84 is a linear polarizer, outputting LHP (rotated) light in arrangements 84A and 84C, and outputting LVP (unrotated) light in arrangements 84B and 84D. That light output indicates the i'th data slot 89 in the case of 85A and 85C, and the complement of 89 in case 85B. In the case of 85D, the light output is the data train 81D with the i'th slot dropped (i.e. set to Off).

Note that conversion/coercion of Clock pulses as RCP pump pulses can be effected locally, so multiple stages could be cascaded together with alternating FIG. 8A or FIG. 8B generating a clean, powerful Clock train, followed by FIG. 8C or FIG. 8D (taking their inputs from the FIG. 8A/FIG. 8B output), followed by FIG. 8A/FIG. 8B, and so forth, so long as the SNR was maintained, e.g. by appropriate amplification stages.

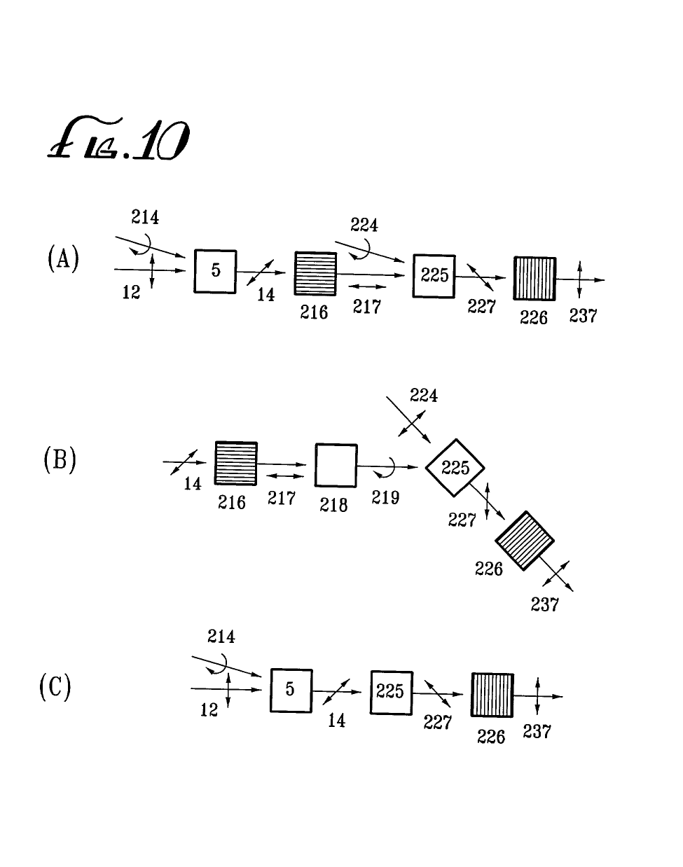

Reference is now made to FIG. 9. Although the preferred embodiment employs one detector, and a matched pair of detectors is an obvious extension, a number of alternative embodiments of the invention may instead benefit from using two or more detectors (along with copies of the Clock, etc.). A multiplicity of interaction regions 62A, 62B, etc. may advantageously be used as indicated in FIG. 9A, or a common interaction region 62 may be used as indicated in FIG. 9B. In general, it can be advantageous to employ a multiplicity of slow detectors in parallel. Element 60 indicates an oblique slice at an instant through an optical wavefront of the illustrative linearly polarized probe beam 63. The beam 63 can be treated as spread in the direction transverse to its direction of propagation or actually replicated as multiple beams. 61 represents a circularly polarized pump beam. 62 represents material in the interaction region. 64 indicates the optical pathlength between 60 and 62. 65 is the probe beam after rotation by the presence of a pump pulse in 61. 66 is the angle between 63 and 61. A multiplicity of photodetection means, such as pixelated detectors 67, can be used to distinguish among the various distances 64. In an alternative embodiment of the invention, an optical means for spreading the beam may be used as 67, so the distinct probe beams can be related to one another. Obviously, the difference in optical pathlengths of each instance of 61A, 62A, etc. versus each respective instance of 64A, 64B, etc., corrected for different refractive indices etc., will ordinarily be matched to the slot-to-slot periodicity similarly corrected. Note that the intervening optics has been omitted from the drawing for clarity's sake.

Ganged detection: The recovery time of the detector and its supporting electronics was mentioned above, and is a practical limit on the frame period and therefore the system duty cycle. If the recovery time needs to be longer than the frame period, multiple detectors can be used to look at multiple (e.g. successive) data bits within each frame, for instance in a round-robin style, trading more parallelism for lower duty cycle per detector.

Redundant detection: Multiply sampling a single data bit can also improve SNR, depending on detector specifics. The clocks would test the value of the symbol in a given slot a number of times n and then use the multiplicity of measurements to determine the value of the symbol in the particular slot. Adding the measurements together gives n scaling of SNR; the measurements could of course be used more adaptively to set the threshold of other detectors, improving SNR more effectively. Multistate logic could also be supported with better SNR by using multiple sampling of a particular slot. Symbols with a multiplicity of intensities could of course be used with full generality as bits of many-level (not just binary) memory.

Tickling: Multiply sampling can be used advantageously at different spacetimes to sample a single data pulse in order to find a centroid or peak, for the purpose of phase-locking a frequency. For instance, several probes might be used together, timed at a sub-slot period to sample an entire slot at sub-slot time-resolution, and then fed to a means for determining the highest intensity (i.e. peak) among these probe values, the position of the peak determining phase of the symbol within the slot. More complicated curve-fitting could of course be used, such as weighted averaging of neighboring sub-slot values. A means for adjusting the pulse repetition rate would then advantageously resynch on the basis of the sub-slot timing data. If the system architecture tolerates variable frame-to-frame jitter but imposes a locally generated Clock, such fine adjustment of the phase may be needed.

Since the probe pulse amplitude can be increased or decreased efficiently (e.g using optical amplifiers or attenuators) without unacceptable loss of SNR, optical logic can be built using this approach. The interaction of a probe and a data bit is itself an AND or NAND operation, depending on whether the linearly polarized beam is passed through a cross polarized or parallel polarized filter, respectively, after interaction with the circularly polarized beam in the interaction region. There are many ways to complement a signal or produce a NOT gate, such as requiring that the probe pulse be present, and setting a polarizer after the probe pulse leaves the interaction region such that the probe leaves a signal if the data symbol is absent and not if the data symbol is present; or, an interferometer could be used to complement the probe value. Summation of a probe bit and a data bit serves as an OR gate. Additional functions can be built by exploiting artifacts of the components (e.g. logical inference (data˜probe) using the non-linear threshold of the detector) or by combining these primitive functions in accordance with deMorgan's rules to build up any of the 16 logical function truth tables. For instance, XOR can be built from (dataVprobe)˜(dataprobe).

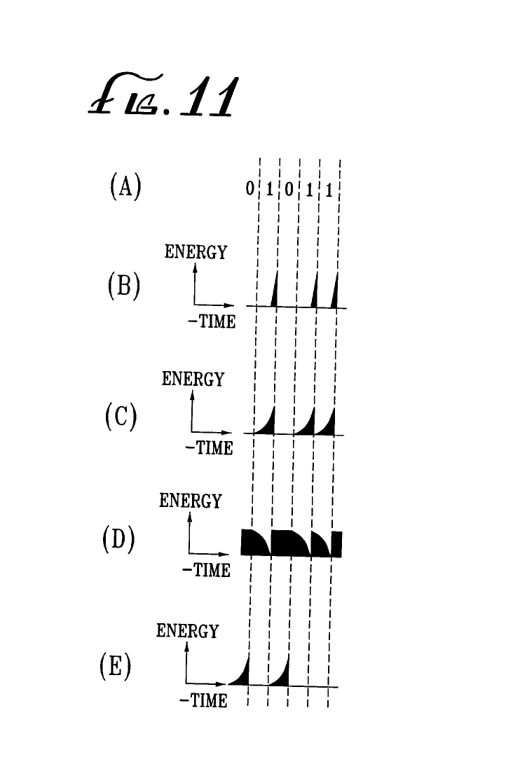

Reference is now made to FIG. 10. FIG. 10A shows a logical AND of pump beams 214 and 224, indicated by the emergence after a fashion as 237 of the LVP probe entering as 12. A LVP probe pulse 12 follows a p'th bit of a RCP pump train 214 into an interaction region 5, exits as a probeOut pulse 14, is filtered by a horizontal polarizer 216, and (if rotated into LHP by the presence of a bit in 214) leaves as 217. The pulse in the slot 217 is synchronized to follow the q'th bit of a second RCP pump train 224 into a second interaction region 225. The pulse in 217 exits 225 as a second probeOut pulse 227, is filtered by the vertical polarizer 226 and (if rotated into LVP by the presence of a bit in 224) leaves as 237. FIG. 10B shows a parity This description and the schematic figures are intended to be indicative and enabling, not comprehensive. Extrapolation using well-known logic circuits is straightforward-and obvious to those skilled in logic design, such as extension to more inputs.

For instance, FIG. 10B redraws FIG. 10A in accordance with the lessons of FIG. 8, so the signal arriving as 14 is used to regenerate a clean linearly polarized pulse source 2240 instead of continuing on itself. The motives for regenerating a signal are discussed elsewhere. A quarter-wave plate 218 can be used to convert 217 into a circularly polarized state 219.

Control over the angle of polarization supports more elegant multi-input logic gates. PARITY, which simplifies to XOR for the case of two inputs, can be measured by subjecting the linearly polarized beam to 90° rotations in succession through cascaded interaction regions, although extracting the linearly polarized beam is preferably done by either counter-propagating it against the circularly polarized beam, which limits the speed or number of inputs, or by co-propagating the beams in different colors and then a grating or comparable means for obtaining the linearly polarized beam. FIG. 10C measures parity, and can be understood as a variant of FIG. 10A, but without needing a polarizer 216 (although intervening polarizers and other optics are of course not precluded). Discrimination at angles other than 90° is useful since the angular rotation will generally be much less than 90°.

IDENTITY can be created by the AND of the data beam with an On probe pulse. A multi-input OR gate can be built using an accumulation of small rotation angles. A multi-input AND gate can be built using 90° rotations through a series of alternately horizontal and vertical polarizing filters Additional optical circuitry for DELAY, and waveguides can be useful for building whole logic subsystems, such as processors, memory, fan-in/out, state machines, and so forth. Numerous arrangements are well-known in the field of logic design, and are anticipated by this invention.

Another notable use of cascaded logic is a gate which toggles an input alternately between two outputs. One embodiment hands off every second data symbol to one output in alternation with a second output line. It can be implemented using, for instance, the data train impressed on the probe beam, a splitter making two copies of the probeout train and respective polarizers, and a pump with exactly every second slot set On. The even numbered data slots will be handed to the splitter at one polarization angle and the odd numbered data slots will be handed to the splitter at another polarization angle. All odd numbered On or Off states and the even numbered Off states can be rejected by an appropriately arranged polarizer after the first split path; all even numbered On or Off states and the odd numbered Off states can be rejected by an appropriately arranged polarizer after the other split path. Another embodiment changes output lines only when an On symbol is read. It can be implemented using well-known logic gates, and can also be used as an RZ to NRZ converter.

Non-trivial logic ordinarily extends for many stages, so requires a way to coerce the output of one stage into a form suitable for the next stage, e.g. from linear into circular polarization. Quarter-wave plates work well. If the probe bit can additionally be coerced into the same polarization state as the data train and copied synchronously into the data train, it is obvious how to build a crude optical memory store using logical feedback in the manner of a flip-flop, not just a delay line. Such a latch can then be used to regenerate the waveforn.

The first challenge with retiming is to find the position of the symbol to be retimed, which usually entails either finding its total energy or else finding its peak or centroid. One retiming method takes the output values of several probe samples interacting with a data slot a fraction of a slot period apart in spacetime, and adds them together to learn the total energy of the symbol. An embodiment uses multiple probe pulse copies, each interacting with a data symbol that progresses through several sequential interaction regions. The probes test the symbol at various spacetimes, the spacetimes advantageously being adjacent, densely sampled, and briefer than the slot period. The results of the interactions can advantageously also be weighted by gain or attenuation, and are then either measured individually or else resynched, ideally by varying path delays, and superposed together. If the probes are measured in approximately one place and time, a second challenge is to avoid the speckle that would result from imperfect constructive interference. These include using a single probe pulse instead of multiple copies, guiding it through multiple interactions with the data slot; circularly polarizing the various probes and using them as a data pulse in one or more different interaction regions to create a new path which a (new or existing) probe pulse can then sample and before it is measured; letting the probe pulses hit a detector slightly splayed in time (i.e. desynched) as independent events to reduce their temporal overlap; aiming the probes at different portions of the detector face, to reduce their spatial overlap; just letting the speckle occur, accepting the complicated spatial averaging; and other approaches in this spirit.

If a reset beam is used, patterns can be modulated on it to assist with retiming and reshaping the probe. The simplest is a sharp leading edge and high intensity, in order to form a tight trailing edge of a square wave probe pulse.

Pulse width modulation is straightforward to implement using the invention, especially if a reset waveform is available. Conversion from RZ into NRZ encoding can be effected in many ways, such as by the customary logic gate embodiment, enhanced by suppressing reset pulses between adjacent On states. An easy way to suppress the reset pulses is to feed the reset line the circularly polarized AND of a SlotClock (pulse train at the slot rate) against the output of the NAND of each adjacent pair of data symbols. Conversion from NRZ into RZ encoding is also straightforward using well-known logic gates, and requires also a SlotClock.

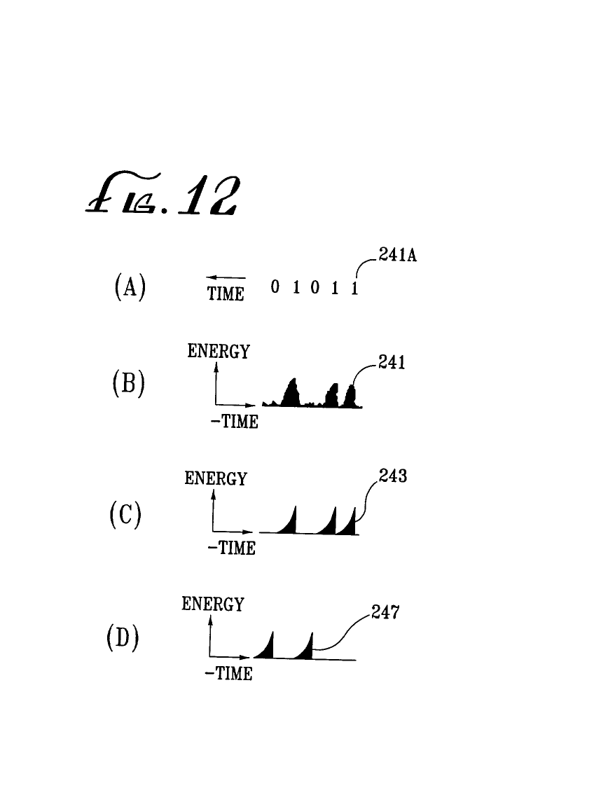

Reference is now made to FIG. 11. FIG. 11A shows a binary bit stream corresponding to an illustrative data train 4 in FIG. 11B. FIG. 11C shows the probeOut beam 17 corresponding to 4. FIG. 11E shows the probeOut waveform of the logical complement 20 of a data train 4 or 17. FIG. 11D shows a bright field complemented probeOut waveform of 17. FIG. 11D is produced by using a continuous (DC) wave linearly polarized beam as the probe beam, so it is ordinarily at full amplitude during Off symbols, with dips and exponentially damped restoration when an On symbol is complemented.

It is useful to produce a complement of a symbol, as distinct from the full waveform, such that the On data symbol yields an Off probe symbol and an Off data symbol yields an On probe symbol, where the Off probe symbol occurs at a base of zero amplitude. The apparatus creating the complement therefore acts on Boolean states as a NAND logic gate. One method for complementing a symbol is to use a vertically polarized probe pulse which, after interaction, passes through a parallel polarized filter (not necessarily vertical, due to static rotation by the optically active materials, and possibly due to essentially time-invariant rotation due to the ambient carrier density). Assume proper alignment of the probe pulse with a symbol in the data beam. If a data slot is Off, the probe pulse will pass through the interaction region and the vertical polarizer at full amplitude, corresponding to being On. If the data slot is On, the probe pulse will be rotated by the interaction region and attenuated by the vertical polarizer, corresponding to being Off. Since the probe pulse will ordinarily be much shorter than the interaction region's recovery time, negligibly little of the probe pulse's tail will be around to get through the interaction region as the rotation recovery restores transparency to vertical polarized light. The output probe beam can, finally, be circularly polarized or otherwise treated further, as discussed above regarding probe output beams.

It is also useful to be able to regenerate a full waveform from the data beam with On and Off symbols complemented—in effect a three-state system with probe pulses interpreted as Off instead of On symbols, but with a pedestal returning to zero in between pulses. Such a complement of the Data beam can be produced by using a pulsed Clock beam with a vertically polarized pulse at exactly the data beam's slot rate. The Clock train should be introduced as the probe beam. A complement of the Data beam is created by vertically filtering said probe beam downstream from the interaction region, so that each Off data symbol lets the synched probe pulse pass unmodulated while each On data symbol causes quick rotation (so the polarizer attenuates it) and then slowly restores the synched probe pulse.

Reconfigurable logic gates can also be built this way. For instance, a stage can be toggled between NOT and IDENTITY functions by exposing a stage to a pump beam with the opposite handedness of the other logic gates, or resetting it, respectively. This works even if the ordinary rotation angle is small (e.g. ±2°).

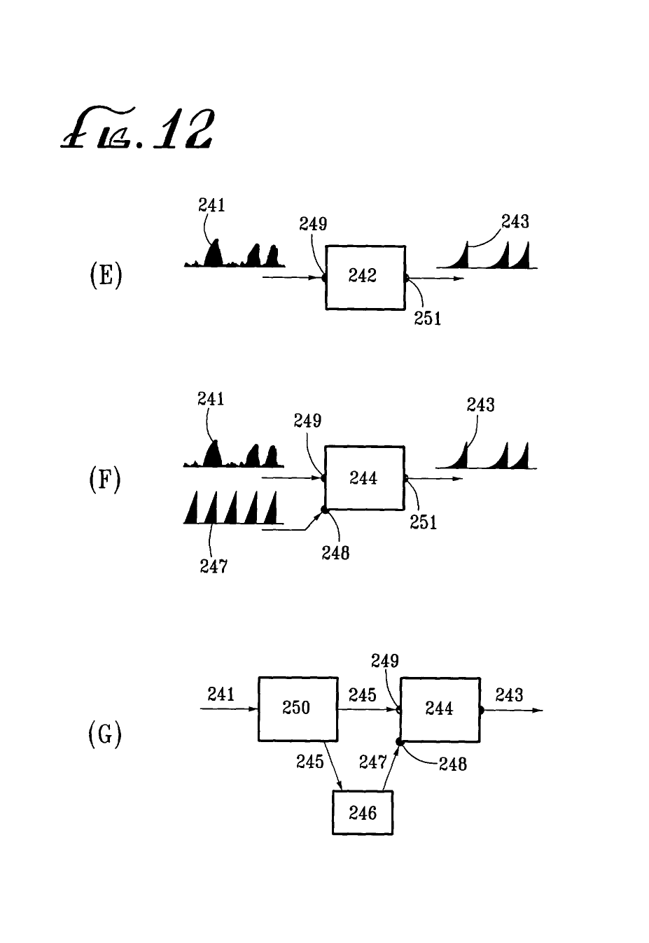

Reference is now made to FIG. 12, sheet 1. FIG. 12A shows a binary bitstream. The bitstream is encoded in FIG. 12B as 241, depicting noisy optical intensities for a DataIn pump waveform of the idealized form 1. FIG. 12C shows a regenerated waveform 243, idealized as a probeOut waveform 17. FIG. 12D shows the complement 247 of regenerated probeOut waveform, idealized as 20. The data train's signal-to-noise ratio will ordinarily degrade as it passes through optical components and degrades via noise, jitter, attenuation or unequalization. The regeneration (i.e. recovery) of cleanly reshaped, reamplified, recolored, and/or retimed On and Off states therefore is useful and can have value. The invention allows regeneration because a clean probe pulse train 244 (idealized as 9) with the desired symbol shape, wavelength (or combination of wavelengths), power level, timing, etc.) can be provided and used to replace a DataIn waveform which has become dirty.

Reference is now made to FIG. 12, sheet 2. FIG. 12E shows an idealized regeneration means 242 converting a dirty input waveform 241 into a regenerated output waveform 243 without use of an external timing reference signal. The regenerator has one input at 249. In practice, such regeneration means operating at high speeds are difficult to implement and generally unsatisfactory due to the difficulty of extracting a Clock signal with the correct (stable, accurate, properly phased) frequency characteristics.

Phase locking the regenerator's probe train laser and the incoming data train's slot rate is essential, since they will not generally be pulsed precisely at the same (i.e. slot) frequency and the output signal amplitude would consequently beat at the reciprocal of the frequency difference. Unfortunately, tying the probe train to the data train's slot rate requires feeding back the latter to force synchronization of the former. Coercing the incoming data train to synch with the new probe train slot rate is more difficult and complicated, since it requires buffering the incoming data train, perhaps to a small fraction of a slot period. Variable frame-to-frame jitter complicates the local generation of a phase-locked Clock signal, so a system architecture will prudently avoid local Clock generation and/or tolerating random frame-to-frame jitter.

As illustrated in FIG. 12F, a two-input regenerator 244 can accept a Clock train input 247 by way of a second input 248. A train of Clock pulses 247 can readily be formed by using a pulsed laser source to provide the pulses as a probe train, instead of just delaying a copy of the data train's Clock pulse. In the simplest embodiment, the probe pulses will still need to be much (e.g. at least 10×) dimmer than the incoming data train pulses, but can have much, much higher SNR (e.g. blacker Off states and RZ coding) and better equalization. Instead of being annihilated in a detector, the modulated probe pulses can advantageously be amplified in an optical amplifier, polarized circularly, and then sent on as the new data train. The noise component, mostly due to amplified spontaneous emission from the optical amplifier, would generally be much smaller than the noise found in the incoming data train.

As illustrated in FIG. 12G, additional optical circuitry could introduce a new Clock pulse at 248 intrinsically synched to the specified time slot. A useful way to create the Clock train is to peel a Clock bit 245 out of the data train 241 by a Clock extractor 250 where it is synchronized by virtue of its known time slot. In 246, the bit is then amplified, replicated, and (if the design warrants) polarized. Intrinsic Clock fan-out works well for creating a Clock train for 3R regeneration (reamplifying, reshaping, and retiming) of the signal if the fan-out mechanism is known to be as frequency stable as the originating time slot generator. Note that phase stability is a special case of frequency stability.

In the presence of noise, the intensity measured at the preferred embodiment's detector varies as the fourth power of the input amplitude. Halving the number of photons in the signal pulse will approximately halve the number of aligned, in-phase carriers and therefore the angle of probe pulse rotation, hence received probe amplitude (for small angles). If the probe pulse is created as a fraction of the signal pulse's energy, halving the signal's amplitude also effectively halves the probe's amplitude as well as its rotation angle, thereby quartering the received amplitude (1/16 of the intensity). If a probe is produced locally, so its amplitude is independent of the data train's amplitude, the detector will see the usual quadratic dependence of detected intensity on the data beam's amplitude.

It can be advantageous to operate at a power level near saturation where the number of carriers created grows only slowly with the energy in a data pulse. That region deamplifies the noise and serves to equalize the output intensity. An optical amplifier in the system some place ahead of extracting the Clock signal can be used to boost the input signal to such a level. In general, gain saturation can be exploited to equalize the signal with this invention. In contrast, prior art approaches which use semiconductor optical amplifiers must reckon with the gain and refractive index being linked, so if such a prior art approach produces an appreciable carrier density, it may be operated deliberately or accidentally in a non-linear gain region.

One way to equalize is to exploit the saturation of the spin sites as a non-linearity limiting the maximum intensity. A sufficiently bright data beam will clamp the On symbols at a high, nearly constant intensity, while the Off symbols will be amplified to various values. Amplification may advantageously be used prior to the interaction region, such as upstream of the spintronic device itself, in order to bring the input beam up to the intensity where non-linear effects matter. Note that equalization can be made to work better by using two or more interaction regions, such as the forms illustrated by {FIG. 8A or FIG. 8B} and {FIG. 8C/FIG. 8D} in alternation, so in some sequence the On states are clamped to 1, the entire bitstream is inverted and the complements of Off states are clamped to 1, and further inversion takes place (or not) as appropriate. Inversion has numerous uses which are well-known to designers of logic and signal processing architectures.

Another way to equalize power levels is to exploit a zero-forcing non-linearity, usually available in the photodetector as a threshold which rejects dim pulses, limiting the minimum intensity. One advantage of such as detector non-linearity is that it allows intensity to be used to distinguish the probe from the data, without needing to distinguish the probe by color or polarization. Intensity scales as the amplitude squared. For instance, begin with a probe pulse which has 10× greater intensity than the data pulses. Split two copies of the data beam, vertically polarizing one copy and using it as the probe beam, and circularly polarizing the other copy; these copies do not need to have the same intensities. Set the relative delay between the beams as needed. After interaction, if the data symbol at the same slot for the probe pulse was On, the probe output beam will have a 10× brighter On symbol there than at its other slots. Note that the probe beam becomes a three-state system, with values for Off (0+noise), On (1+noise), and ON (10+Noise) symbols (assuming small values for noise and Noise). This downstream probe pulse can then be read by a suitably thresholded detector which rejects the merely On symbols as Off but accepts the ON symbol as On, or can be subjected to further stages of filtering.

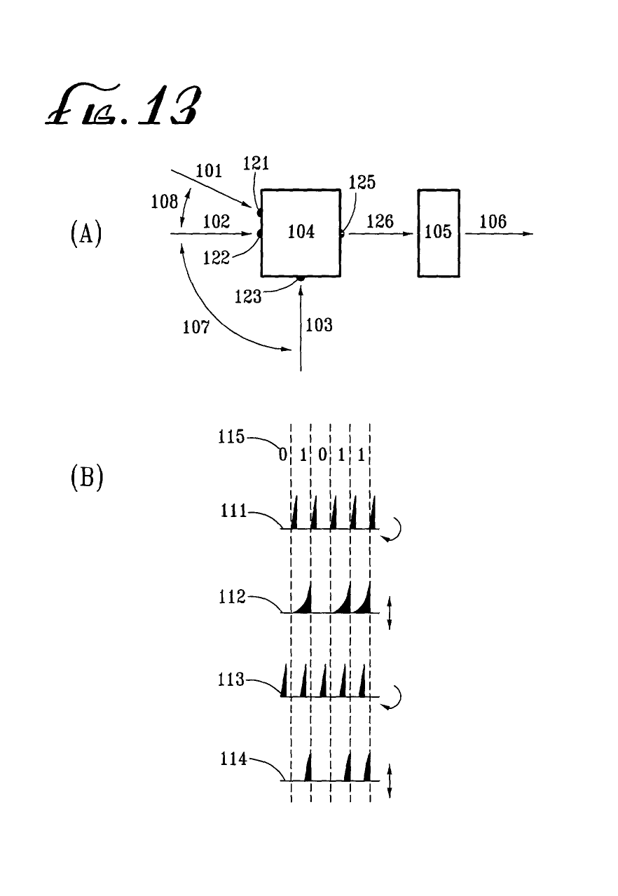

Reference is now made to FIG. 13. If its intensity is high enough to realign most of the spins, a circularly polarized reset beam 103 transverse to a circularly polarized pump beam 101 will effectively erase the prior history of the pump beam by removing the net angular momentum of the spins in the spintronic material seen along the path seen by the linearly polarized probe beam 102. Resetting the spintronic device essentially “slams shuts the gate” and cuts off the slow exponential tail given by the dephasing of the pumped spins, as depicted in pulse train 114 versus 111. A reset beam can therefore also be used to dampen noise, by reducing the number of spin sites and thereby darkening the Off states.

Preferably, the optically active region is exposed to a cycle of circular pump, linear probe, and circular reset pulses indefinitely, starting with any phase. The cycle requires little enough delay between pump and probe that the spins do not dephase unacceptably. Depending on the operating mode, there either needs to be sufficient delay (e.g. 0.3 psec) between the pump and probe for excitons to dissipate, or little enough delay that the excitons are observed. Orienting a strong magnetic axis anti-parallel to the pump axis can increase the rotational contrast between On and Off pulses. The probe axis can be parallel or anti-parallel to the probe axis, as needed. Either the pump or probe beam can carry the modulated data. Alternatives to pulses are discussed elsewhere in this disclosure.

An embodiment of this invention as a four terminal optical shutter 104 is particularly non-obvious compared to the prior art. These lessons still apply when used with a device comprising: three optical inputs and an optical output, as well as a spintronic material and optional linearly polarized output filter 105. A first optical input 121 introduces a circularly polarized pump beam 101 carrying a signal 111. A second optical input 122 introduces the linearly polarized pump beam 102 carrying a signal 112. Waveform 112 is modulated here, but, as indicated in FIG. 8, either the pump or probe beam can carry the modulated data. A third optical input 123 introduces a circularly polarized reset beam 103. The optical output 125 carries the rotated, linearly polarized DataOut beam 126, which produces waveform 114 at 106. Element 105 indicates a linearly polarized output filter and a means for extracting the probe beam and suppressing the pump beam (such as angle, color, etc.). The polarization filter is aligned with the rotation corresponding to the Off or On state (depending on the device's definition as AND or NAND) in order to pass only the other state. The simplest embodiment overlaps 121 with 122. A beam dump for the 101 beam after its interaction with 102 is implicit.

There are many ways to create the reset signal 103. It can be done with delayed replicas of the pump beam, so Ons follow Offs and Offs follow Offs; or it can be done with Ons in every slot, which has the advantage of darkening noisy Off symbols but the disadvantage of adding to the ambient carrier density in the material in the interaction region 104. In other words, the reset signal should have Ons wherever bitstream 115 shows On symbols, but it may be preferable to have all of its symbols on, especially if a clean SlotClock is available. Waveform 113 provides the reset signal in this example. The circularly polarized beam used for the reset signal could be generated, remotely or locally, at the slot periodicity, synched to each frame start, as illustrated in 114. Or, it could be generated as a lagged replica of 101, which avoids complexities of resynching to accommodate frame-to-frame jitter.

Note the truncation (reshaping) indicated in each symbol in 114 due to the cancellation (resetting) of the active optical material in 104 after the pump waveform 112 Sets it. A four-terminal device can preferably be used in the manner of an RS “flip-flop” or “sample-and-hold” latch, notably as in the manner of dynamic random access memory or an analog peak detector. Other uses of such samplers are well known in the electronics literature. For instance, it is well established in the spintronics literature that memory cells can be set to On states and allowed to decay to Off, but the invention disclosed herein adds the prospect of a memory cell setting Off states too, as well as leaving a cell On until turned off so long as the decay is long compared to the useful recycling time. A canonical configuration uses a material and structure designed to dephase deliberately slowly compared to the recycle time, as well as a reset path 123.

The simple efficiency relation between the pump and probe beams 108 is just the absolute value of the cosine of 108. However, the angle 107 between the pump and reset beams is more complicated and important than such a simple relationship, due to the very nonlinearities the invention advantageously exploits. The rotation of the probe's polarization angle, which a circularly polarized pulse induces, depends upon the pulse's energy and the prior instant's spin phase, among other things. The amount of rotation is usually non-linear due to several factors, notably gain compression when many (>>10%) of the spins are aligned by a dimmer pulse than the one being used. For instance, the reset pulse may effectively act as a new pump pulse rather than erasing the effect of the preceding pump pulse. The intensity of the reset pulse will seldom match the time-decayed effective intensity of the pump pulse at a given instant.

It is enabling of this invention and of obvious extensions of it to describe the parallel, anti-parallel, and transverse orientation cases between the pump beam and a strong reset beam more precisely, since the generalization extends obviously to all angles 107 and energies. If the pump and reset beams are perpendicular, as assumed above, the prior pump beam's energy history will be erased, regardless of the circularly polarized reset beam's handedness, and regardless of the linearly polarized probe beam's orientation. However, the reset beam can be introduced anti-parallel to the pump beam (e.g. at 125), in which case it should be given the same handedness as the pump beam. If the reset beam is introduced parallel to the pump beam (e.g. at 126, it should have opposite handedness. When a reset beam is applied from any angle that is not perpendicular to the pump beam, an important consequence is that the system effectively becomes three-state instead of binary. Define angle Z° such that the probe beam is rotated by Z on average. The angle Z° will be non-zero if the material induces a static rotation, and especially if the optically active material induces a baseline rotation due to an average ambient carrier density, as discussed above. The polarization angle of the probe beam will be maximally rotated to angle Z°+X° if the measured pump pulse was On, corresponding to some history, a reset pulse, a delay, an On symbol being pumped, and then the probe. The polarization of the probe beam will be maximally rotated to angle Z°+X° if the measured pump pulse was Off, corresponding to some history, then a reset, followed by a delay, followed by the probe. If left alone, the system will eventually restore to angle Z° with exponential time dependence. A three-state system has the advantage of greater (roughly doubled) contrast between the On and Off rotation angles of the probe, assuming that a linear polarizing filter is correctly oriented perpendicular to Z°+X° or Z°−X°, rather than to Z°. A three-state system has the disadvantage of being more sensitive to the precise timing among pump, probe, and reset pulses, largely because the Off states are made negative rather than zero, and also of being more sensitive to noise.

Of course, a second pump beam can be used in the manner of a parallel reset beam in order to shore up a sagging decay, prolonging the persistence of an On state.

Whether or not a reset is used, the invention can make the carrier density irrelevant. Carrier density plagues prior art approaches since it causes appreciable, long-lived but time-varying rotation, i.e. a history. The carrier density can be normalized out in accordance with this invention while the psec-scale decoherence time is exploited in isolation, even if the carrier density is large due to an extensive history from prior data. Normalization is accomplished by building the system such that the slot rate (e.g. psec) is much faster than the time scale for carrier recombination (e.g. at least 10's of times longer), in order to ensure that a rough stability in the amount of power (usually meaning the number of On symbols per nsec of data stream) seen by the optically active region provides a stable background against which the psec-scale phenomena can be modulated and sampled. In other words, since the density of hot carriers can be kept more or less constant, though non-zero, on the time frame of the slot rate, the carriers can be treated as a static background contributing an essentially time-invariant rotation of the probe beam by a fixed angle, in addition to the time-dependent change in probe polarization angle induced (principally if not entirely) by the most recent slot symbol. Note that static rotation has been discussed elsewhere.

It is advantageous to darken the Off symbols as a means for improving the On/Off ratio. Ideally, a reset pulse is used after every On symbol, so a reset beam can be formed from a replica of the data beam itself or from a pulse train at the slot period or some slower period. Each pulse from the reset beam should be submitted to the interaction region after the i'th probe pulse and before the next (i.e. i+1) data pulse. The introduction of a circularly polarized reset pulse along a path transverse to the propagation of the circularly polarized pump beam will erase the net angular momentum remembered by the spin sites along the probe beam's path, and thereby restore the system to a more thoroughly Off state. Of course, if the configuration uses a linearly polarized data probe beam and circularly polarized pump Clock beam, the reset beam would still be oriented transverse to the pump beam's path, as indicated above in FIG. 13. By transverse we mean with dependence as the absolute value of the sine of the angle. If a magnet is used, the optimal reset beam path may most conveniently be along the magnetic axis or perpendicular to it. A means for absorbing or reflecting the reset beam may advantageously be used.

A replica of the circularly polarized data beam can itself be used as the reset beam, if relatively lagged slightly in time and introduced at right angles. The use of a locally generated reset beam at precisely the slot rate will of course be assured crisper rising & falling edges, and will also darken the Off states.

Note that if the pump beam sets only a minority of the spin sites for an On state, a reset beam of comparable amplitude would be quadratically inefficient in restoring sites to an Off state: half the pump & reset intensities would be one-fourth as efficient at darkening. If the pump beam sets a majority of the spin sites for an On state, a reset beam of comparable amplitude would be very efficient at darkening the system. So long as the reset beam's amplitude is significantly brighter than the pump beam's amplitude, such as by producing the reset beam locally or favoring it in a non-50:50 splitter replicating the pump beam, the system's fastest slot rate need not be limited by memory effects arising from a high amplitude pump beam. This use of a reset beam has great value in compensating for an over-bright pump beam.

Carrier heating and depletion are manageable practical considerations because the spins prepared into an On orientation decorrelate very quickly, superposing their net effect to zero, and the On state can also be converted/reset into an Off state (from the perspective of the probe beam) by being exposed to a bright reset pulse oriented transverse to the circularly polarized beam's optical axis. Note that “bright” in idealized terms means bright enough to reorient much more than 50% of the spin sites; in practical terms bright means more than about 10% of the data symbol amplitude, since a reset pulse would ordinarily be applied slightly later than the pump pulse, when the spins in the interaction region had already begun to decorrelate and lose their net angular momentum from the vantage of the probe beam.

In the examples herein, the apparatus modulates the efficiency of transmission to achieve its effect. Yet, substantially all of the lessons taught in this document can be applied equivalently to diffractive, refractive, and reflective systems for transporting optical energy, as well as to combinations and hybrids of them. Additional arrangements of such systems are well known to practitioners of modern optics, in analogy to work with lenses, mirrors, and non-linear elements, and the invention is intended to apply to such foreseeable apparatuses. Many permutations (e.g. change caused briefly by an Off symbol instead of or in addition to change caused briefly by an On symbol; NRZ coding; reflection versus transmission having depth or color dependence; RCP versus LCP light; etc.) are obvious, trivial extensions. It is the inventor's intent that such lessons should be read as applying to these other equivalent arrangements too.

Alternative embodiments of the invention can use such constructs as multiple quantum wells (MQW), two dimensional electron gases (2DEG), epilayer interfaces, bulk material such as lightly doped ZnSe, or other devices (e.g. an etalon based on a MQW stack) whose reflectivity and/or transmittivity can be altered when their spins are spintronically pumped into a coherent orientation. The defect level may need to be very high (e.g. SiN) or very low to be maximally effective.

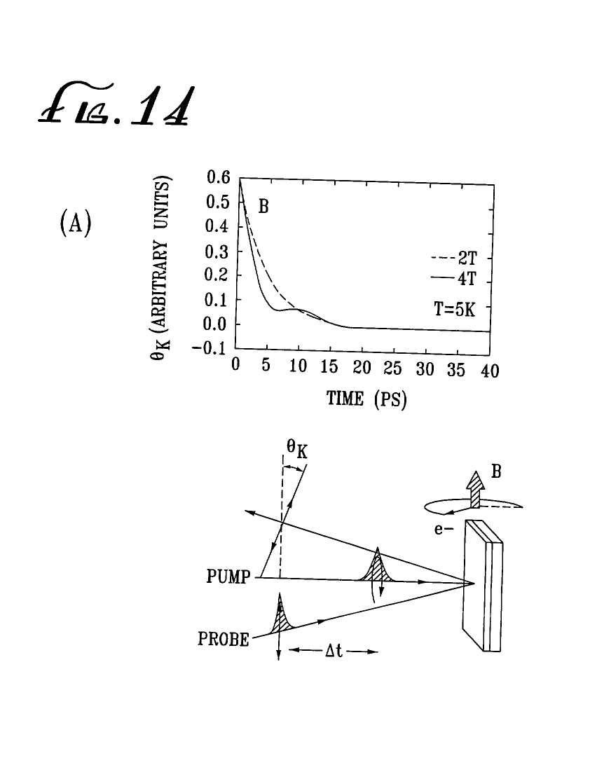

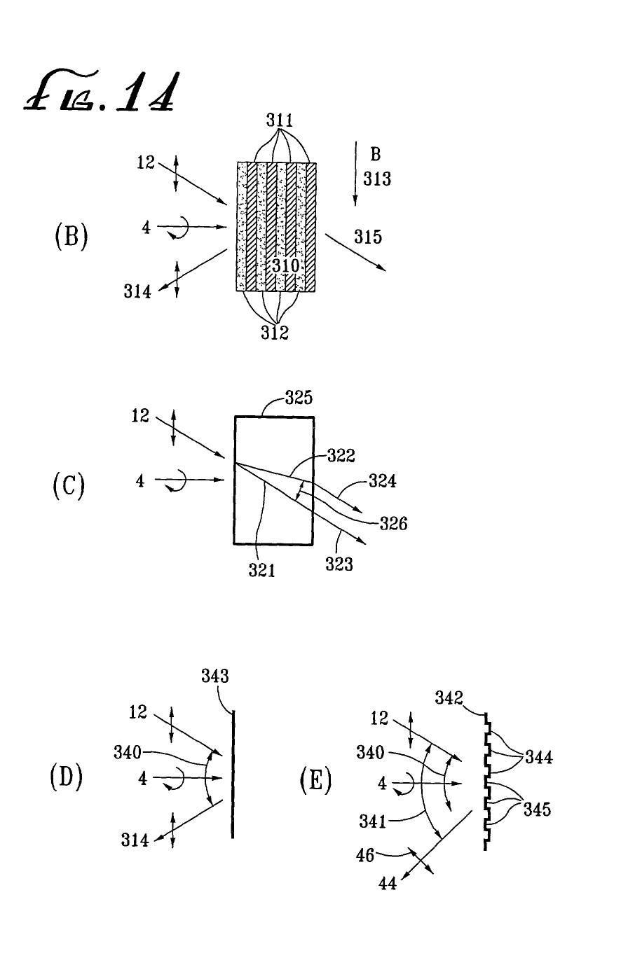

FIG. 14A shows prior art which modulates the polarization angle of a reflected linearly polarized probe beam, inducing a Kerr rotation by reflection from an interaction region (e.g. ZnSe at cryo temperatures) whose spins have been reoriented temporarily by exposure to a circularly polarized pump beam. Passage through a polarizer after the interaction region can then be used to learn the time dependent rotation of the linearly polarized probe beam. That prior art was used to study the basic spintronic properties of matter, uncomplicated by any notion of using those properties to store an information state or level (symbol) or read a purposefully set information state or level. In comparison, the invention disclosed herein deliberately uses time-dependent optical patterns data to read or write information states by way of an optically active region of spintronic material.

FIG. 14B shows an embodiment of the invention using reflection to modulate the amplitude of a reflected probe beam (strictly speaking, the reflective efficiency) directly, apart from or in combination with a rotation of the polarization angle, said amplitude modulation being induced by reflection from an interaction region whose spins have been reoriented temporarily by exposure to a circularly polarized data beam. The material in this figure is depicted as a Bragg reflector 310, so is formed from alternating layers of materials 311 and 312 with contrasting refractive indices, the invention modulating one or both of those indices. Other well-known ways to form Bragg reflectors include 311 forming substantially all of the volume, and 312 being a very thin surface, e.g. an etalon. It will be advantageous to use a material whose refractive index depends on spin orientation apart from carrier density. The best optically active spintronic materials in the literature decouple the spin state from the carrier density at low incident pump power. A variety of tricks well-known to optics practitioners can be used to good effect, such as using anti-reflection coatings, looking at the relative weightings of TE and TM modes, or applying a static magnetic field. The reflected probeOut waveform is 314, and a transmitted version is 315. An optional B field is labeled 313.

FIG. 14C shows an embodiment using birefringence of first or second order, and exploits the time-dependent variable birefringence of an interaction region 315 exposed to a circularly polarized pump beam 4 to modulate the relative intensities of a pair of linearly polarized probe beams created in the material as 321 and 322, possibly with a splitting angle 326, and leave the material as 323 and 324.

The figure can also be read as an embodiment using refraction (i.e. with or without birefringence), exploiting the time-dependent variable refractive index of an interaction region exposed to a circularly polarized data beam to modulate the position, hence locally measured intensity, of a linearly polarized probe beam. In this embodiment, the beam 12 will leave the material at 323 or 324, depending on whether the pump 4 was Off or On.

These embodiments can both advantageously be used to shift the probe by λ/2, supporting interferometric enhancement of the ending positions, especially if the exit paths 323 and 324 are separated by λ/2, 3λ/2, etc. The relative pathlengths are particularly easy to modulate if the refractive index is modulated. Unless interferometry is used, the separation of 323 and 324 should be many wavelengths for ease of construction. Differential measurement can be used productively since the relative intensities of the two beams will vary.

Of course, any item among the set {birefringence, refractive index, impedance, reflectivity, opacity, emissivity, refractivity, transmittivity, diffractivity}, singly or in some combination, can be contrasted in accordance with the invention if it has a spintronic effect, so all such embodiments of spintronics are therefore taught to be equivalent. In general, an optically active interaction region exposed to a circularly polarized pump beam which modulates the position or amplitude of a linearly polarized probe beam, yields an all-optical logical AND or NAND operation. This operation is notably useful when one input is given by a data signal carried by one of the beams and another input is given by a clock signal carried by the other.

It is worth noting that the density of spins reoriented by the data beam waveform, which depends upon the waveform's recent power among other things, governs the amount of rotation of linear polarization and affects the refractive index and reflectivity efficiency, all in time-dependent ways. Embodiments of the invention will be notably effective at modulating the polarization rotation, efficiency of reflection, transmission, refraction, etc., if they include interfaces between different materials, particularly systems with a laminated structure, especially laminates comprising layers whose thickness is approximately comparable to half the wavelength of light divided by the nominal refractive index corrected by Snell's law for the angle of incidence.

FIG. 14D and FIG. 14E contrast the case of reflection versus diffraction for illustrative purposes. The embodiment exploits the time-dependent variable reflectivity or transmittivity of a corrugated surface shape to alter the diffraction or reflection of a probe beam. A number of designs for multi-state diffraction gratings can be used, such as a well-known binary system with blazings favoring one direction, and gratings caused to be present briefly by exposure to an On symbol. Many permutations (e.g. gratings caused to be absent, etc.) are trivial and obvious.

In the absence of a pump pulse, the surface 343 reflects the incident probe beam 12 about the normal by an overall angle 340. Now consider a surface with relatively high-T₂* and low-T₂* materials alternately striped across it, which can be done using standard lithographic processes well-known in the semiconductor industry. The contrasting time constants allow an optically controllable spintronic diffraction grating formed from 344 versus 345 to emerge, in essence allowing switching between two holograms. A diffraction grating is briefly present when excited by a pump signal, so the DataOut probe signal 44 emerges at an angle 341 instead of 340.

As with all of the examples in FIG. 14, the complementary case applies too, where the pattern is present in the absence of the Clock, and absent in the presence of the Clock. Likewise, Other orders will of course be present unless deliberately suppressed.

Materials with slow dephasing can be useful too. Consider a material which appears uniform to light passing through it, but has been patterned with regions of different spin densities. After that material is pumped, regions of coherent spin will emerge briefly, causing impedance mismatches at their boundaries. Parallel planes of these regions, spaced λ/2 apart, can be “enabled” and used to form a high efficiency distributed Bragg reflectors (DBR). More generally, the regions can be holograms and do not need to be flat or continuous. The plane(s) to be enabled in this example can have fixed or variable positions. If variable, a means is required for selecting which planes to enable, and can be provided by well-known techniques including: selecting all planes and then electrically quenching or optically resetting (thereby dephasing) all planes up to the needed ones; optoelectronically selecting only the needed planes in the first place, such as by masking or setting their susceptibility to pumping with a liquid crystal display mask or holes injected from electrodes; or a combination. Some applications benefiting from such a DBR may include a programmable delay line, a reconfigurable switch with many possible inputs or outputs, or a dynamically adaptive mirror surface, among others.

Consider a system including a photonic bandgap material which ordinarily has structures present to guide light, but which is designed to lose certain of those structures and/or gain certain other structures when the spins in those structures are forced into phase by being pumped. An embodiment of the invention disclosed herein can enable such a system, advantageously by using very rapid or very slow dephasing. Such a system—as well as variants of it and others well-known to practitioners in optoelectronics, electro-optics, and photonics—can serve a number of useful analog and digital applications.

A further class of examples, the dynamic reconfiguration of logic gates, has already been described above. Dynamic reconfiguration of interconnection networks tying together fixed-purpose gates, dynamically reconfigurable gates, and/or other devices can be accomplished using, for instance, the two exemplary methods described immediately above.

It is the intention that the disclosure herein be understood broadly, and extrapolated to variants, combinations, applications and cases which are well-known to those skilled in the art as implied by the disclosure as a whole. Although particular embodiments of the present invention have been shown and described herein, it will be understood that it is not intended to limit the invention to the preferred embodiments and it will be obvious to those skilled in the art that various changes and modifications may be made without departing from the spirit and scope of the present invention. Thus, the invention is intended to cover alternatives, modifications, and equivalents, which may be included within the spirit and scope of the invention as defined by the claims.

All publications, patents, and patent applications cited herein are hereby incorporated by reference in their entirety for all purposes.

What I claim is:

1. An apparatus, comprising:
a first signal channel for accepting a linearly polarized optical waveform;
a second channel for accepting an elliptically polarized optical waveform;
a region of spintronic material coupled to said first channel and said second channel, said linearly polarized optical waveform and said elliptically polarized optical waveform interact in said region and said region comprising an InGaAs multiple quantum well structure;
a third channel coupled to said region, said third channel for outputting a linearly polarized optical waveform from said region; and
a polarizing filter for discriminating the polarization angle of said third channel from said first channel.
